(19) United States
(12) Patent Application Publication
(10) Pub. No.: US 2026/0136348 A1
(43) Pub. Date: May 14, 2026

(54) TECHNIQUES FOR ALLOCATING NON-LINEAR DISTORTION TO SPATIAL LAYERS

(71) Applicant: QUALCOMM Incorporated, San Diego, CA (US)

(72) Inventors: Igor GUTMAN, Hod HaSharon (IL); Ori SHENTAL, Marlboro, NJ (US); Junyi LI, Greentown, PA (US); Tao LUO, San Diego, CA (US)

(21) Appl. No.: 18/948,317

(22) Filed: Nov. 14, 2024

(51) Int. Cl. H04W 72/044; H04B 7/0456; H04W 72/0453; H04W 72/1268

(52) U.S. Cl. CPC H04W 72/046; H04B 7/0456; H04W 72/0453; H04W 72/1268

(57) ABSTRACT

Methods, systems, and devices for wireless communications are described. A user equipment may receive a first control signal that indicates a distortion management configuration for an uplink transmission by the UE. The distortion management configuration may indicate a plurality of spatial layers to use and may indicate a proportion of non-linear distortion to allocate to each spatial layer of the plurality of spatial layers. The UE may receive a control message indicating to transmit an uplink message. The UE may precode the uplink message to generate a precoded message for transmission via the plurality of spatial layers in accordance with the distortion management configuration. The UE may transmit the precoded message via the plurality of spatial layers in accordance with the control message.

### FIELD OF TECHNOLOGY

The following relates to wireless communications, including techniques for allocating non-linear distortion to spatial layers.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

### SUMMARY

The systems, methods, and devices of this disclosure each have several innovative aspects, no single one of which is solely responsible for the desirable attributes disclosed herein.

A method for wireless communications by a user equipment (UE) is described. The method may include receiving a first control signal that indicates a distortion management configuration for an uplink transmission by the UE, where the distortion management configuration indicates a set of multiple spatial layers to use and indicates a proportion of non-linear distortion to allocate to each spatial layer of the set of multiple spatial layers, receiving a control message indicating to transmit an uplink message, precoding the uplink message to generate a precoded message for transmission via the set of multiple spatial layers in accordance with the distortion management configuration, and transmitting the precoded message via the set of multiple spatial layers in accordance with the control message.

A UE for wireless communications is described. The UE may include one or more memories storing processor executable code, and one or more processors coupled with the one or more memories. The one or more processors may individually or collectively be operable to execute the code to cause the UE to receive a first control signal that indicates a distortion management configuration for an uplink transmission by the UE, where the distortion management configuration indicates a set of multiple spatial layers to use and indicates a proportion of non-linear distortion to allocate to each spatial layer of the set of multiple spatial layers, receive a control message indicating to transmit an uplink message, precode the uplink message to generate a precoded message for transmission via the set of multiple spatial layers in accordance with the distortion management configuration, and transmit the precoded message via the set of multiple spatial layers in accordance with the control message.

Another UE for wireless communications is described. The UE may include means for receiving a first control signal that indicates a distortion management configuration for an uplink transmission by the UE, where the distortion management configuration indicates a set of multiple spatial layers to use and indicates a proportion of non-linear distortion to allocate to each spatial layer of the set of multiple spatial layers, means for receiving a control message indicating to transmit an uplink message, means for precoding the uplink message to generate a precoded message for transmission via the set of multiple spatial layers in accordance with the distortion management configuration, and means for transmitting the precoded message via the set of multiple spatial layers in accordance with the control message.

A non-transitory computer-readable medium storing code for wireless communications is described. The code may include instructions executable by one or more processors to receive a first control signal that indicates a distortion management configuration for an uplink transmission by the UE, where the distortion management configuration indicates a set of multiple spatial layers to use and indicates a proportion of non-linear distortion to allocate to each spatial layer of the set of multiple spatial layers, receive a control message indicating to transmit an uplink message, precode the uplink message to generate a precoded message for transmission via the set of multiple spatial layers in accordance with the distortion management configuration, and transmit the precoded message via the set of multiple spatial layers in accordance with the control message.

In some examples of the method, user equipment (UEs), and non-transitory computer-readable medium described herein, the distortion management configuration indicates one or more frequencies associated with each spatial layer of the set of multiple spatial layers, the distortion management configuration indicating the proportion of non-linear distortion to allocate to the one or more frequencies.

In some examples of the method, user equipment (UEs), and non-transitory computer-readable medium described herein, the one or more frequencies include one or more in-band frequencies or one or more out-of-band frequencies.

Some examples of the method, user equipment (UEs), and non-transitory computer-readable medium described herein may further include operations, features, means, or instructions for determining a performance metric associated with the precoded message, where the performance metric may be determined for the set of multiple spatial layers.

In some examples of the method, user equipment (UEs), and non-transitory computer-readable medium described herein, the performance metric may be an error vector magnitude metric or an out-of-band metric associated with each spatial layer of the set of multiple spatial layers.

Some examples of the method, user equipment (UEs), and non-transitory computer-readable medium described herein may further include operations, features, means, or instructions for receiving an indication of a channel matrix associated with the uplink message, where the uplink message may be precoded based on the channel matrix.

In some examples of the method, user equipment (UEs), and non-transitory computer-readable medium described herein, the proportion of non-linear distortion to allocate to each spatial layer of the set of multiple spatial layers may be based on a quality of service of a data payload of the uplink message.

Some examples of the method, user equipment (UEs), and non-transitory computer-readable medium described herein may further include operations, features, means, or instructions for receiving a second control signal that indicates a quality of service indicator associated with the uplink message, where the proportion of non-linear distortion to allocate to each spatial layer of the set of multiple spatial layers may be based on the quality of service indicator.

In some examples of the method, user equipment (UEs), and non-transitory computer-readable medium described herein, the proportion of non-linear distortion to allocate to each spatial layer of the set of multiple spatial layers may be based on a channel characteristic.

A method for wireless communications by a UE is described. The method may include receiving a control message indicating to transmit an uplink message, precoding the uplink message to generate a precoded message for transmission via a set of multiple spatial layers in accordance with a distortion management configuration, where the distortion management configuration indicates a proportion of non-linear distortion to allocate to each spatial layer of the set of multiple spatial layers, and transmitting the precoded message via the set of multiple spatial layers in accordance with the distortion management configuration.

A UE for wireless communications is described. The UE may include one or more memories storing processor executable code, and one or more processors coupled with the one or more memories. The one or more processors may individually or collectively be operable to execute the code to cause the UE to receive a control message indicating to transmit an uplink message, precode the uplink message to generate a precoded message for transmission via a set of multiple spatial layers in accordance with a distortion management configuration, where the distortion management configuration indicates a proportion of non-linear distortion to allocate to each spatial layer of the set of multiple spatial layers, and transmit the precoded message via the set of multiple spatial layers in accordance with the distortion management configuration.

Another UE for wireless communications is described. The UE may include means for receiving a control message indicating to transmit an uplink message, means for precoding the uplink message to generate a precoded message for transmission via a set of multiple spatial layers in accordance with a distortion management configuration, where the distortion management configuration indicates a proportion of non-linear distortion to allocate to each spatial layer of the set of multiple spatial layers, and means for transmitting the precoded message via the set of multiple spatial layers in accordance with the distortion management configuration.

A non-transitory computer-readable medium storing code for wireless communications is described. The code may include instructions executable by one or more processors to receive a control message indicating to transmit an uplink message, precode the uplink message to generate a precoded message for transmission via a set of multiple spatial layers in accordance with a distortion management configuration, where the distortion management configuration indicates a proportion of non-linear distortion to allocate to each spatial layer of the set of multiple spatial layers, and transmit the precoded message via the set of multiple spatial layers in accordance with the distortion management configuration.

In some examples of the method, user equipment (UEs), and non-transitory computer-readable medium described herein, the distortion management configuration indicates a distortion management matrix and the distortion management matrix indicates a weighting factor to apply to a respective spatial layer of the set of multiple spatial layers.

In some examples of the method, user equipment (UEs), and non-transitory computer-readable medium described herein, the distortion management configuration indicates one or more frequencies associated with each spatial layer of the set of multiple spatial layers and the distortion management configuration indicates the proportion of non-linear distortion to allocate to the one or more frequencies.

Some examples of the method, user equipment (UEs), and non-transitory computer-readable medium described herein may further include operations, features, means, or instructions for receiving a control signal that indicates the distortion management configuration.

In some examples of the method, user equipment (UEs), and non-transitory computer-readable medium described herein, the distortion management configuration indicates one or more frequencies associated with each spatial layer of the set of multiple spatial layers and the distortion management configuration indicates the proportion of non-linear distortion to allocate to the one or more frequencies.

Some examples of the method, user equipment (UEs), and non-transitory computer-readable medium described herein may further include operations, features, means, or instructions for determining a performance metric associated with the precoded message, where the performance metric may be determined for the set of multiple spatial layers.

In some examples of the method, user equipment (UEs), and non-transitory computer-readable medium described herein, the performance metric may be an error vector magnitude metric or an out-of-band metric associated with each spatial layer of the set of multiple spatial layers.

Some examples of the method, user equipment (UEs), and non-transitory computer-readable medium described herein may further include operations, features, means, or instructions for receiving an indication of a channel matrix associated with the uplink message, where the uplink message may be precoded based on the channel matrix.

In some examples of the method, user equipment (UEs), and non-transitory computer-readable medium described herein, the proportion of non-linear distortion to allocate to each spatial layer of the set of multiple spatial layers may be based on a quality of service of a data payload of the uplink message.

Some examples of the method, user equipment (UEs), and non-transitory computer-readable medium described herein may further include operations, features, means, or instructions for receiving a control signal that indicates a quality of service indicator associated with the uplink message, where the proportion of non-linear distortion to allocate to each spatial layer of the set of multiple spatial layers may be based on the quality of service indicator.

In some examples of the method, user equipment (UEs), and non-transitory computer-readable medium described herein, the proportion of non-linear distortion to allocate to each spatial layer of the set of multiple spatial layers may be based on a channel characteristic.

A method for wireless communications by a first network equipment is described. The method may include outputting, to a UE, a first control signal that indicates a first distortion management configuration for an uplink transmission by the UE, where the first distortion management configuration indicates a set of multiple spatial layers to use and indicates a proportion of non-linear distortion to allocate to each spatial layer of the set of multiple spatial layers, outputting, to the UE, a control message indicating that the UE is to transmit an uplink message, and obtaining, from the UE, the uplink message via the set of multiple spatial layers in accordance with the control message and the first distortion management configuration.

A first network equipment for wireless communications is described. The first network equipment may include one or more memories storing processor executable code, and one or more processors coupled with the one or more memories. The one or more processors may individually or collectively be operable to execute the code to cause the first network equipment to output, to a UE, a first control signal that indicates a first distortion management configuration for an uplink transmission by the UE, where the first distortion management configuration indicates a set of multiple spatial layers to use and indicates a proportion of non-linear distortion to allocate to each spatial layer of the set of multiple spatial layers, output, to the UE, a control message indicating that the UE is to transmit an uplink message, and obtain, from the UE, the uplink message via the set of multiple spatial layers in accordance with the control message and the first distortion management configuration.

Another first network equipment for wireless communications is described. The first network equipment may include means for outputting, to a UE, a first control signal that indicates a first distortion management configuration for an uplink transmission by the UE, where the first distortion management configuration indicates a set of multiple spatial layers to use and indicates a proportion of non-linear distortion to allocate to each spatial layer of the set of multiple spatial layers, means for outputting, to the UE, a control message indicating that the UE is to transmit an uplink message, and means for obtaining, from the UE, the uplink message via the set of multiple spatial layers in accordance with the control message and the first distortion management configuration.

A non-transitory computer-readable medium storing code for wireless communications is described. The code may include instructions executable by one or more processors to output, to a UE, a first control signal that indicates a first distortion management configuration for an uplink transmission by the UE, where the first distortion management configuration indicates a set of multiple spatial layers to use and indicates a proportion of non-linear distortion to allocate to each spatial layer of the set of multiple spatial layers, output, to the UE, a control message indicating that the UE is to transmit an uplink message, and obtain, from the UE, the uplink message via the set of multiple spatial layers in accordance with the control message and the first distortion management configuration.

In some examples of the method, first network equipment, and non-transitory computer-readable medium described herein, the first distortion management configuration indicates one or more frequencies associated with each spatial layer of the set of multiple spatial layers and the first distortion management configuration indicating the proportion of non-linear distortion to allocate to the one or more frequencies.

In some examples of the method, first network equipment, and non-transitory computer-readable medium described herein, the one or more frequencies include one or more in-band frequencies or one or more out-of-band frequencies.

Some examples of the method, first network equipment, and non-transitory computer-readable medium described herein may further include operations, features, means, or instructions for determining a performance metric associated with the uplink message, where the performance metric may be determined for the set of multiple spatial layers.

In some examples of the method, first network equipment, and non-transitory computer-readable medium described herein, the performance metric may be an error vector magnitude metric or an out-of-band metric associated with each spatial layer of the set of multiple spatial layers.

Some examples of the method, first network equipment, and non-transitory computer-readable medium described herein may further include operations, features, means, or instructions for obtaining, from a second network entity, a second control signal indicating a second distortion management configuration associated with one or more spatial layers of the set of multiple spatial layers, where the second distortion management configuration indicates to allocate a non-linear distortion or to refrain from allocating the non-linear distortion to the one or more spatial layers of the set of multiple spatial layers.

Some examples of the method, first network equipment, and non-transitory computer-readable medium described herein may further include operations, features, means, or instructions for outputting, to a second network entity, a second control signal indicating a second distortion management configuration associated with one or more spatial layers of the set of multiple spatial layers, where the second distortion management configuration indicates to allocate a non-linear distortion or to refrain from allocating the non-linear distortion to the one or more spatial layers of the set of multiple spatial layers.

Some examples of the method, first network equipment, and non-transitory computer-readable medium described herein may further include operations, features, means, or instructions for outputting an indication of a channel matrix associated with the uplink message.

In some examples of the method, first network equipment, and non-transitory computer-readable medium described herein, the proportion of non-linear distortion to allocate to each spatial layer of the set of multiple spatial layers may be based on a quality of service of a data payload of the uplink message.

Some examples of the method, first network equipment, and non-transitory computer-readable medium described herein may further include operations, features, means, or instructions for outputting, to the UE, a second control signal that indicates a quality of service indicator associated with the uplink message, where the proportion of non-linear distortion to allocate to each spatial layer of the set of multiple spatial layers may be based on the quality of service indicator.

In some examples of the method, first network equipment, and non-transitory computer-readable medium described herein, the proportion of non-linear distortion to allocate to each spatial layer of the set of multiple spatial layers may be based on a channel characteristic.

Details of one or more implementations of the subject matter described in this disclosure are set forth in the accompanying drawings and the description below. Other features, aspects, and advantages will become apparent from the description, the drawings, and the claims. Note that the relative dimensions of the following figures may not be drawn to scale.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages will be better understood from the following description when considered in connection with the accompanying figures. Each of the figures is provided for the purposes of illustration and description, and not as a definition of the limits of the claims.

While aspects and embodiments are described in this application by illustration to some examples, those skilled in the art will understand that additional implementations and use cases may come about in many different arrangements and scenarios. Innovations described herein may be implemented across many differing platform types, devices, systems, shapes, sizes, packaging arrangements. For example, embodiments and/or uses may come about via integrated chip embodiments and other non-module-component based devices (e.g., end-user devices, vehicles, communication devices, computing devices, industrial equipment, retail/purchasing devices, medical devices, artificial intelligence (AI)-enabled devices, etc.). While some examples may or may not be specifically directed to use cases or applications, a wide assortment of applicability of described innovations may occur. Implementations may range in spectrum from chip-level or modular components to non-modular, non-chip-level implementations and further to aggregate, distributed, or original equipment manufacturer (OEM) devices or systems incorporating one or more aspects of the described innovations. In some practical settings, devices incorporating described aspects and features may also necessarily include additional components and features for implementation and practice of claimed and described embodiments. For example, transmission and reception of wireless signals necessarily includes a number of components for analog and digital purposes (e.g., hardware components including antenna, radio frequency (RF)-chains, power amplifiers, modulators, buffer, processor(s), interleaver, adders/summers, etc.). It is intended that innovations described herein may be practiced in a wide variety of devices, chip-level components, systems, distributed arrangements, end-user devices, etc. of varying sizes, shapes, and constitution.

### BRIEF DESCRIPTION OF THE DRAWINGS

FIG. 1 shows an example of a wireless communications system that supports techniques for allocating non-linear (NL) distortion to spatial layers in accordance with one or more aspects of the present disclosure.

FIG. 2 shows an example of a wireless communications system that supports techniques for allocating NL distortion to spatial layers in accordance with one or more aspects of the present disclosure.

FIG. 3 shows an example of a block diagram that supports techniques for allocating NL distortion to spatial layers in accordance with one or more aspects of the present disclosure.

FIG. 4 shows an example of a block diagram that supports techniques for allocating NL distortion to spatial layers in accordance with one or more aspects of the present disclosure.

FIG. 5 shows an example of a process flow that supports techniques for allocating NL distortion to spatial layers in accordance with one or more aspects of the present disclosure.

FIGS. 6 and 7 show block diagrams of devices that support techniques for allocating NL distortion to spatial layers in accordance with one or more aspects of the present disclosure.

FIG. 8 shows a block diagram of a communications manager that supports techniques for allocating NL distortion to spatial layers in accordance with one or more aspects of the present disclosure.

FIG. 9 shows a diagram of a system including a device that supports techniques for allocating NL distortion to spatial layers in accordance with one or more aspects of the present disclosure.

FIGS. 10 and 11 show block diagrams of devices that support techniques for allocating NL distortion to spatial layers in accordance with one or more aspects of the present disclosure.

FIG. 12 shows a block diagram of a communications manager that supports techniques for allocating NL distortion to spatial layers in accordance with one or more aspects of the present disclosure.

FIG. 13 shows a diagram of a system including a device that supports techniques for allocating NL distortion to spatial layers in accordance with one or more aspects of the present disclosure.

FIGS. 14 through 18 show flowcharts illustrating methods that support techniques for allocating NL distortion to spatial layers in accordance with one or more aspects of the present disclosure.

### DETAILED DESCRIPTION

In some examples, a wireless communication system may include a user equipment (UE) transmitting messages to a network entity. To perform the transmissions, the UE may contain non-linear (NL) components, such as high power amplifiers (PA) with a limited linear dynamic range, and the NL components may distort the transmitted signals due to high peak-to-average power ratio (PAPR). The NL distortions may be in-band distortion that affects the link performance in the sense of mutual information or error vector magnitude (EVM) and out-band (OOB) distortion, that may have limits due to regulatory constraints. To minimize the distortions, power back-off (BO) may be introduced; however, a higher BO may result in less power efficiency with less power being transmitted to the medium and more power being dissipated as heat.

Techniques for allocating NL distortion to spatial layers may be employed. In some examples, a transmitter may balance or control the NL distortion by shifting NL distortion from one spatial layer to another spatial layer associated with multiple input multiple output (MIMO) techniques using multiple antennas. For example, a UE may receive a distortion management configuration for an uplink transmission. The distortion management configuration may indicate a plurality of spatial layers that the UE is to use for an uplink transmission, and the distortion management configuration may indicate a proportion of NL distortion to allocated to a respective spatial layer of the plurality of spatial layers. The UE may receive a control message indicating to transmit an uplink message. The UE may precode the uplink message to generate a precoded message for transmission via the plurality of spatial layers in accordance with the distortion management configuration. The UE may transmit the precoded message via the plurality of spatial layers in accordance with the control message. In some examples, the distortion management configuration may indicate one or more frequencies associated with each spatial layer of the plurality of spatial layers, and the distortion management configuration may indicate the proportion of NL distortion to apply to the one or more frequencies. The frequencies may be in-band frequencies or out-of-band frequencies. The proportion of NL distortion to apply to a respective spatial layer of the plurality of spatial layers may be based on a quality of service of a data payload of the uplink message or a channel characteristic.

Aspects of the disclosure are initially described in the context of wireless communications systems. Aspects of the disclosure are further illustrated by and described with reference to block diagrams, process flow, apparatus diagrams, system diagrams, and flowcharts that relate to techniques for allocating NL distortion to spatial layers.

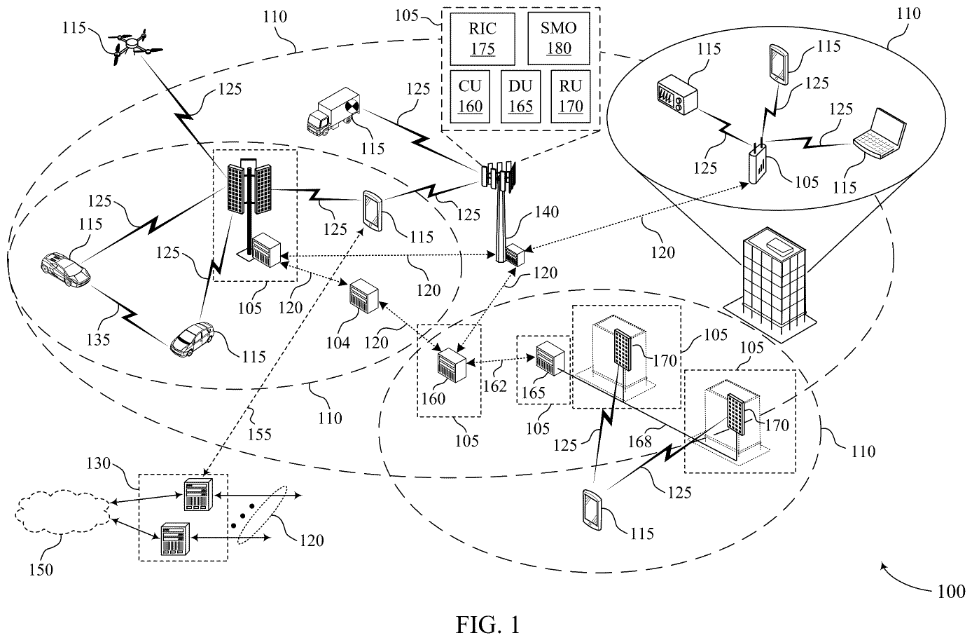

FIG. 1 shows an example of a wireless communications system 100 that supports techniques for allocating NL distortion to spatial layers in accordance with one or more aspects of the present disclosure. The wireless communications system 100 may include one or more devices, such as one or more network devices (e.g., network entities 105), one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via communication link(s) 125 (e.g., a radio frequency (RF) access link). For example, a network entity 105 may support a coverage area 110 (e.g., a geographic coverage area) over which the UEs 115 and the network entity 105 may establish the communication link(s) 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices in the wireless communications system 100 (e.g., other wireless communication devices, including UEs 115 or network entities 105), as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with a core network 130, or with one another, or both. For example, network entities 105 may communicate with the core network 130 via backhaul communication link(s) 120 (e.g., in accordance with an S1, N2, N3, or other interface protocol). In some examples, network entities 105 may communicate with one another via backhaul communication link(s) 120 (e.g., in accordance with an X2, Xn, or other interface protocol) either directly (e.g., directly between network entities 105) or indirectly (e.g., via the core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication link(s) 120, midhaul communication links 162, or fronthaul communication links 168 may be or include one or more wired links (e.g., an electrical link, an optical fiber link) or one or more wireless links (e.g., a radio link, a wireless optical link), among other examples or various combinations thereof. A UE 115 may communicate with the core network 130 via a communication link 155.

One or more of the network entities 105 or network equipment described herein may include or may be referred to as a base station 140 (e.g., a base transceiver station, a radio base station, an NR base station, an access point, a radio transceiver, a NodeB, an eNodeB (eNB), a next-generation NodeB or giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within one network entity (e.g., a network entity 105 or a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among multiple network entities (e.g., network entities 105), such as an integrated access and backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU), such as a CU 160, a distributed unit (DU), such as a DU 165, a radio unit (RU), such as an RU 170, a RAN Intelligent Controller (RIC), such as an RIC 175 (e.g., a Near-Real Time RIC (Near-RT RIC), a Non-Real Time RIC (Non-RT RIC)), a Service Management and Orchestration (SMO) system, such as an SMO system 180, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more of the network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending on which functions (e.g., network layer functions, protocol layer functions, baseband functions, RF functions, or any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., Radio Resource Control (RRC), service data adaptation protocol (SDAP), Packet Data Convergence Protocol (PDCP)). The CU 160 (e.g., one or more CUs) may be connected to a DU 165 (e.g., one or more DUs) or an RU 170 (e.g., one or more RUs), or some combination thereof, and the DUs 165, RUs 170, or both may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or multiple different RUs, such as an RU 170). In some cases, a functional split between a CU 160 and a DU 165 or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to a DU 165 via a midhaul communication link 162 (e.g., F1, F1-c, F1-u), and a DU 165 may be connected to an RU 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities (e.g., one or more of the network entities 105) that are in communication via such communication links.

In some wireless communications systems (e.g., the wireless communications system 100), infrastructure and spectral resources for radio access may support wireless backhaul link capabilities to supplement wired backhaul connections, providing an IAB network architecture (e.g., to a core network 130). In some cases, in an IAB network, one or more of the network entities 105 (e.g., network entities 105 or IAB node(s) 104) may be partially controlled by each other. The IAB node(s) 104 may be referred to as a donor entity or an IAB donor. A DU 165 or an RU 170 may be partially controlled by a CU 160 associated with a network entity 105 or base station 140 (such as a donor network entity or a donor base station). The one or more donor entities (e.g., IAB donors) may be in communication with one or more additional devices (e.g., IAB node(s) 104) via supported access and backhaul links (e.g., backhaul communication link(s) 120). IAB node(s) 104 may include an IAB mobile termination (IAB-MT) controlled (e.g., scheduled) by one or more DUs (e.g., DUs 165) of a coupled IAB donor. An IAB-MT may be equipped with an independent set of antennas for relay of communications with UEs 115 or may share the same antennas (e.g., of an RU 170) of IAB node(s) 104 used for access via the DU 165 of the IAB node(s) 104 (e.g., referred to as virtual IAB-MT (vIAB-MT)). In some examples, the IAB node(s) 104 may include one or more DUs (e.g., DUs 165) that support communication links with additional entities (e.g., IAB node(s) 104, UEs 115) within the relay chain or configuration of the access network (e.g., downstream). In such cases, one or more components of the disaggregated RAN architecture (e.g., the IAB node(s) 104 or components of the IAB node(s) 104) may be configured to operate according to the techniques described herein.

For instance, an access network (AN) or RAN may include communications between access nodes (e.g., an IAB donor), IAB node(s) 104, and one or more UEs 115. The IAB donor may facilitate connection between the core network 130 and the AN (e.g., via a wired or wireless connection to the core network 130). That is, an IAB donor may refer to a RAN node with a wired or wireless connection to the core network 130. The IAB donor may include one or more of a CU 160, a DU 165, and an RU 170, in which case the CU 160 may communicate with the core network 130 via an interface (e.g., a backhaul link). The IAB donor and IAB node(s) 104 may communicate via an F1 interface according to a protocol that defines signaling messages (e.g., an F1 AP protocol). Additionally, or alternatively, the CU 160 may communicate with the core network 130 via an interface, which may be an example of a portion of a backhaul link, and may communicate with other CUs (e.g., including a CU 160 associated with an alternative IAB donor) via an Xn-C interface, which may be an example of another portion of a backhaul link.

IAB node(s) 104 may refer to RAN nodes that provide IAB functionality (e.g., access for UEs 115, wireless self-backhauling capabilities). A DU 165 may act as a distributed scheduling node towards child nodes associated with the IAB node(s) 104, and the IAB-MT may act as a scheduled node towards parent nodes associated with IAB node(s) 104. That is, an IAB donor may be referred to as a parent node in communication with one or more child nodes (e.g., an IAB donor may relay transmissions for UEs through other IAB node(s) 104). Additionally, or alternatively, IAB node(s) 104 may also be referred to as parent nodes or child nodes to other IAB node(s) 104, depending on the relay chain or configuration of the AN. The IAB-MT entity of IAB node(s) 104 may provide a Uu interface for a child IAB node (e.g., the IAB node(s) 104) to receive signaling from a parent IAB node (e.g., the IAB node(s) 104), and a DU interface (e.g., a DU 165) may provide a Uu interface for a parent IAB node to signal to a child IAB node or UE 115.

For example, IAB node(s) 104 may be referred to as parent nodes that support communications for child IAB nodes, or may be referred to as child IAB nodes associated with IAB donors, or both. An IAB donor may include a CU 160 with a wired or wireless connection (e.g., backhaul communication link(s) 120) to the core network 130 and may act as a parent node to IAB node(s) 104. For example, the DU 165 of an IAB donor may relay transmissions to UEs 115 through IAB node(s) 104, or may directly signal transmissions to a UE 115, or both. The CU 160 of the IAB donor may signal communication link establishment via an F1 interface to IAB node(s) 104, and the IAB node(s) 104 may schedule transmissions (e.g., transmissions to the UEs 115 relayed from the IAB donor) through one or more DUs (e.g., DUs 165). That is, data may be relayed to and from IAB node(s) 104 via signaling via an NR Uu interface to MT of IAB node(s) 104 (e.g., other IAB node(s)). Communications with IAB node(s) 104 may be scheduled by a DU 165 of the IAB donor or of IAB node(s) 104.

In the case of the techniques described herein applied in the context of a disaggregated RAN architecture, one or more components of the disaggregated RAN architecture may be configured to support techniques for allocating NL distortion to spatial layers as described herein. For example, some operations described as being performed by a UE 115 or a network entity 105 (e.g., a base station 140) may additionally, or alternatively, be performed by one or more components of the disaggregated RAN architecture (e.g., components such as an IAB node, a DU 165, a CU 160, an RU 170, an RIC 175, an SMO system 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, vehicles, or meters, among other examples.

The UEs 115 described herein may be able to communicate with various types of devices, such as UEs 115 that may sometimes operate as relays, as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via the communication link(s) 125 (e.g., one or more access links) using resources associated with one or more carriers. The term “carrier” may refer to a set of RF spectrum resources having a defined PHY layer structure for supporting the communication link(s) 125. For example, a carrier used for the communication link(s) 125 may include a portion of an RF spectrum band (e.g., a bandwidth part (BWP)) that is operated according to one or more PHY layer channels for a given RAT (e.g., LTE, LTE-A, LTE-A Pro, NR). Each PHY layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities, such as one or more of the network entities 105).

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

The time intervals for the network entities 105 or the UEs 115 may be expressed in multiples of a basic time unit which may, for example, refer to a sampling period of Tₛ=1/(Δfₘₐₓ·N_{f}) seconds, for which Δfₘₐₓ may represent a supported subcarrier spacing, and N_{f} may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively-numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems, such as the wireless communications system 100, a slot may further be divided into multiple mini-slots associated with one or more symbols. Excluding the cyclic prefix, each symbol period may be associated with one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (sTTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to UEs 115 (e.g., one or more UEs) or may include UE-specific search space sets for sending control information to a UE 115 (e.g., a specific UE).

In some examples, a network entity 105 (e.g., a base station 140, an RU 170) may be movable and therefore provide communication coverage for a moving coverage area, such as the coverage area 110. In some examples, coverage areas 110 (e.g., different coverage areas) associated with different technologies may overlap, but the coverage areas 110 (e.g., different coverage areas) may be supported by the same network entity (e.g., a network entity 105). In some other examples, overlapping coverage areas, such as a coverage area 110, associated with different technologies may be supported by different network entities (e.g., the network entities 105). The wireless communications system 100 may include, for example, a heterogeneous network in which different types of the network entities 105 support communications for coverage areas 110 (e.g., different coverage areas) using the same or different RATs.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs (e.g., one or more of the UEs 115) via a device-to-device (D2D) communication link, such as a D2D communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communications may support a one-to-many (1:M) system in which each UE 115 transmits to one or more of the UEs 115 in the group. In some examples, a network entity 105 may facilitate the scheduling of resources for D2D communications. In some other examples, D2D communications may be carried out between the UEs 115 without an involvement of a network entity 105.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than one hundred kilometers) compared to communications using the smaller frequencies and longer waves of the high frequency (HF) or very high frequency (VHF) portion of the spectrum below 300 MHz.

The wireless communications system 100 may utilize both licensed and unlicensed RF spectrum bands. For example, the wireless communications system 100 may employ License Assisted Access (LAA), LTE-Unlicensed (LTE-U) RAT, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

The network entities 105 or the UEs 115 may use MIMO communications to exploit multipath signal propagation and increase spectral efficiency by transmitting or receiving multiple signals via different spatial layers. Such techniques may be referred to as spatial multiplexing. The multiple signals may, for example, be transmitted by the transmitting device via different antennas or different combinations of antennas. Likewise, the multiple signals may be received by the receiving device via different antennas or different combinations of antennas. Each of the multiple signals may be referred to as a separate spatial stream and may carry information associated with the same data stream (e.g., the same codeword) or different data streams (e.g., different codewords). Different spatial layers may be associated with different antenna ports used for channel measurement and reporting. MIMO techniques include single-user MIMO (SU-MIMO), for which multiple spatial layers are transmitted to the same receiving device, and multiple-user MIMO (MU-MIMO), for which multiple spatial layers are transmitted to multiple devices.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

The UEs 115 and the network entities 105 may support retransmissions of data to increase the likelihood that data is received successfully. Hybrid automatic repeat request (HARQ) feedback is one technique for increasing the likelihood that data is received correctly via a communication link (e.g., the communication link(s) 125, a D2D communication link 135). HARQ may include a combination of error detection (e.g., using a cyclic redundancy check (CRC)), forward error correction (FEC), and retransmission (e.g., automatic repeat request (ARQ)). HARQ may improve throughput at the MAC layer in relatively poor radio conditions (e.g., low signal-to-noise conditions). In some examples, a device may support same-slot HARQ feedback, in which case the device may provide HARQ feedback in a specific slot for data received via a previous symbol in the slot. In some other examples, the device may provide HARQ feedback in a subsequent slot, or according to some other time interval.

In some examples, a wireless communication system may include the UE 115 transmitting messages to the network entity 105. To perform the transmissions, the UE 115 may contain NL components, such as PAs with a limited linear dynamic range, and the NL components may distort the transmitted signals due to high PAPR. The NL distortions may be in-band distortion that affects the link performance in the sense of mutual information or EVM and OOB distortion, that may have limits due to regulatory constraints. To minimize the distortions, power BO may be introduced; however, a higher BO may result in less power efficiency with less power being transmitted to the medium and more power being dissipated as heat.

Techniques for allocating NL distortion to spatial layers may be employed. In some examples, a transmitter may balance or control the NL distortion by shifting the NL distortion from one spatial layer to another spatial layer associated with multiple input multiple output (MIMO) techniques using multiple antennas. For example, a UE 115 may receive a distortion management configuration for an uplink transmission. The distortion management configuration may indicate a plurality of spatial layers that the UE 115 is to use for an uplink transmission, and the distortion management configuration may indicate a proportion of NL distortion to allocate to each spatial layer of the plurality of spatial layers. The UE 115 may receive a control message indicating to transmit an uplink message. The UE 115 may precode the uplink message to generate a precoded message for transmission via the plurality of spatial layers in accordance with the distortion management configuration. The UE 115 may transmit the precoded message via the plurality of spatial layers in accordance with the control message. In some examples, the distortion management configuration may indicate one or more frequencies associated with a respective spatial layer of the plurality of spatial layers, and the distortion management configuration may indicate the proportion of NL distortion to apply to the one or more frequencies. The frequencies may be in-band frequencies or out-of-band frequencies. The proportion of NL distortion to apply to each spatial layer of the plurality of spatial layers may be based on a quality of service of a data payload of the uplink message or a channel characteristic.

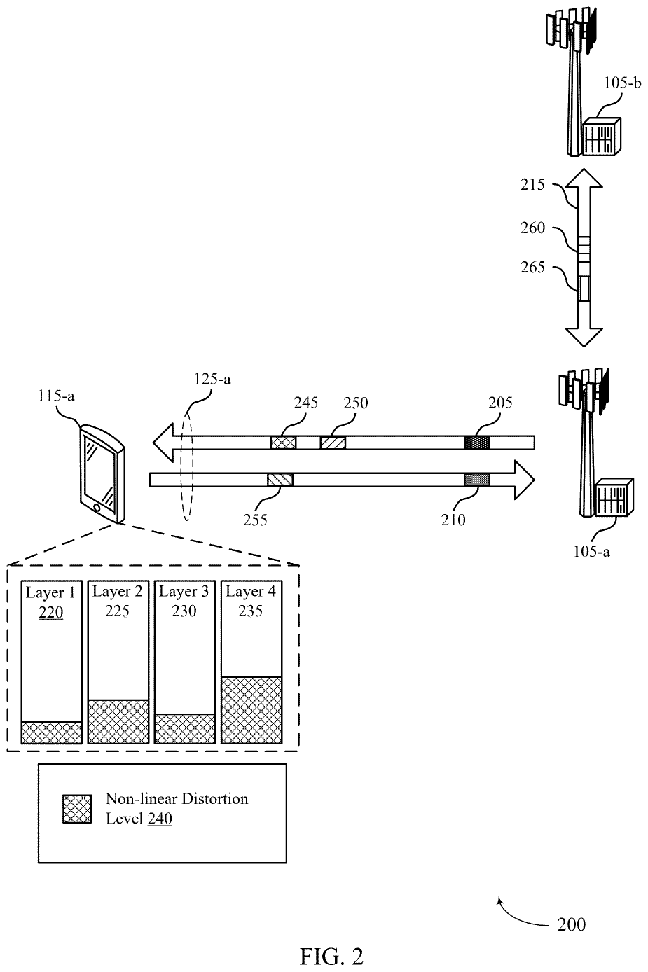

FIG. 2 shows an example of a wireless communications system 200 that supports techniques for allocating NL distortion to spatial layers in accordance with one or more aspects of the present disclosure. The wireless communications system 200 may implement aspects of or may be implemented by aspects of the wireless communications system 100. For example, the wireless communications system 200 includes a UE 115-a, a network entity 105-a, and a network entity 105-b, which may be examples of a UE 115 and a network entity 105 as described herein.

The UE 115-a may communicate with the network entity 105-a using a communication link 125- a. The communication link 125- a may be an example of a 6th generation (6G), a NR or LTE link between the UE 115-a and the network entity 105-a. The communication link 125-a may include bi-directional links that enable both uplink and downlink communications. For example, the network entity 105-a may transmit downlink signals (e.g., downlink message 205), such as downlink control signaling and downlink data signals, to the UE 115-a using the communication link 125-a, and the UE 115-a may transmit uplink signals (e.g., uplink message 210), including uplink control signaling and uplink data signals to the network entity 105-a using the communication link 125-a.

The network entity 105-a may communicate with the network entity 105-b using a communication link 215. The communication link 215 may be an example of a backhaul communication link 120, midhaul communication link 162, fronthaul communication link 168, or another communication link. The communication link 215 may include bi-directional links. For example, the network entity 105-a may transmit signals to the network entity 105-b using the communication link 215, and the network entity 105-b may transmit signals to the network entity 105-a using the communication link 215.

In some examples, the UE 115-a may transmit the uplink message 210 to the network entity 105-a. The utilization efficiency of a radiated power to transmit the uplink message may play a significant role in wireless system design. The UE 115-a may include a transmitter that includes NL components, such as high-power amplifiers (PA) with a limited linear dynamic range, and the PAs may distort the transmitted signal due to high PAPR. A source of NL distortion may be from pushing the PA to a NL region to benefit from increased energy efficiency. The NL distortions may be classified as in-band distortion that affects the communication link performance in the sense of mutual information or error vector magnitude (EVM) and out of band (OOB) distortion that may have some limits due to regulatory constraints. To avoid or reduce the in-band and OOB distortions, a power back-off (BO) may be introduced, however, the power BO may be associated with a downside. For example, higher power BO reduces the power efficiency, so less power is transmitted to the medium and more power is dissipated as heat.

In some examples, the transmitter may implement alternatives to power BO. For example, the transmitter may implement PAPR reduction schemes which reduce the PAPR of the signal at the input of the PA to allow the application of a smaller power BO with improved PA efficiency. The PAPR reduction schemes may use extra bandwidth, limited EVM and in general do not reduce the PAPR below threshold values without performance reductions. Another alternative may be a digital pre-distorter (DPD). The DPD may linearize the NL polynomial response of the PA up to a clipping level and may reduce the BO up to a theoretical PAPR level. Another alternative may be digital post distortion (DPoD) that, like the DPD, may linearize the NL response of the PA in the receiver. The DPoD performance may be similar to the DPD. These alternatives may not deal with clipping that limits the performance, and these alternatives do not use the spatial domain.

For MIMO with multiple ports in the transmitter of the UE 115-a, the NL distortion from the PA may not be the same among the multiple ports over the time. At any given time, the NL distortion of the PA on port A may be different than the NL distortion of the PA on port B. This difference in NL distortion between the ports is correct if the signal is different per port; for example, due to precoding or multi-layer transmission. The different signal per port provides a different instantaneous power (IP) per port at any given time, and since the impact of the PA strongly depends on the IP, the impact of the PA is different per port. In some cases, the PA impact per port may be balanced or controlled. The NL distortion effect at one port may be shifted to another port per instant with controlled effect on the OOB and EVM.

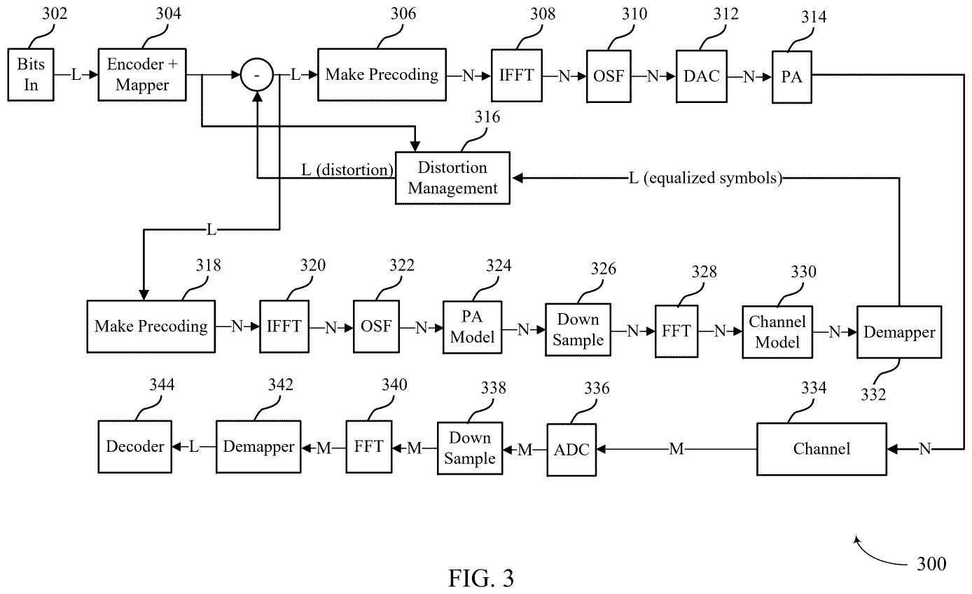

FIG. 3 shows an example of a block diagram 300 that supports techniques for allocating NL distortion to spatial layers in accordance with one or more aspects of the present disclosure. The block diagram 300 may implement aspects of or may be implemented by aspects of the wireless communications system 100 and wireless communications system 200. For example, the block diagram 300 may be implemented by the UE 115-a and the network entity 105-a.

The block diagram 300 illustrates a technique for allocating NL distortion to spatial layers for a transmitter device (e.g., UE 115-a or network entity 105-a) and a receiver device (e.g., UE 115-a or network entity 105-a). At the transmitter device, information bits in block 302 feeds to a encoder+mapper block 304. After the encoder+mapper block 304, the information bits are a frequency domain signal with L layers, where L is a positive integer. The receiver device may include the make precoding block 306 that precodes the frequency domain signal with L layers to N transmitter ports (wideband precoding (WB) or sub-band precoding (SB)). From the make precoding block 306, a frequency domain signal with N transmitter ports may be fed to an inverse fast Fourier transform (IFFT) block 308 that converts the frequency domain signal for transmission onto available subcarriers that feeds to an oversampling factor (OSF) block 310. After the OSF block 310, is a digital to analog converter (DAC) block 312 and a PA 314. After the PA 314, the signal is transmitted over the channel 334 to the receiver device. In some cases, a PAPR reduction and a DPD may be implemented between the OSF block 310 and the DAC block 312. For example, the PAPR reduction and DPD may deal with the PA 314 while the precoding is matched to the over the air (OTA) channel. In some examples, using the PAPR reduction and DPD may find local optimums but not a global optimum.

For the transmitter device with allocation of NL distortion to spatial layers, the PAPR reduction and DPD may not be used. Instead of the PAPR reduction and DPD, the transmitter device may include a distortion management block 316. The frequency domain signal with L layers may be fed to the distortion management block 316. The transmitter device with allocation of NL distortion to spatial layers includes a make precoding block 318, an IFFT block 320, a OSF block 322, a PA model block 324, a down sample block 326, a fast Fourier transform (FFT) block 328, a channel model block 330 and a demapper block 332. The output of the demapper block 332 of L equalized symbols is fed to the distortion management block 316 that outputs the allocated distortion for the L layers. The transmitter device with allocation of NL distortion to spatial layers solves the global optimum instead of the local optimum provided by the PAPR reduction and DPD. The receiver device includes a ADC block 336, a down sample block 338, a FFT block 340, a demapper block 342, and a decoder block 344, which outputs bits decoded from the received signal. The receiver device remains the same as a baseline receiver and is not affected by the allocation of NL distortion by the transmitter device. In the proposed scheme, the OTA channel as well as the NL model of the PAs are known to the transmitter device. The NL distortion allocation technique may iteratively determine or model an optimal distortion per layer due to the entire end-to-end (E2E) model of the precoder, the PA, the channel, and the decoder, and the NL distortion allocation technique may control the total distortion by distributing it among the layers or dimensions (e.g., spatial layers, frequency, other dimensions, or other subdimensions).

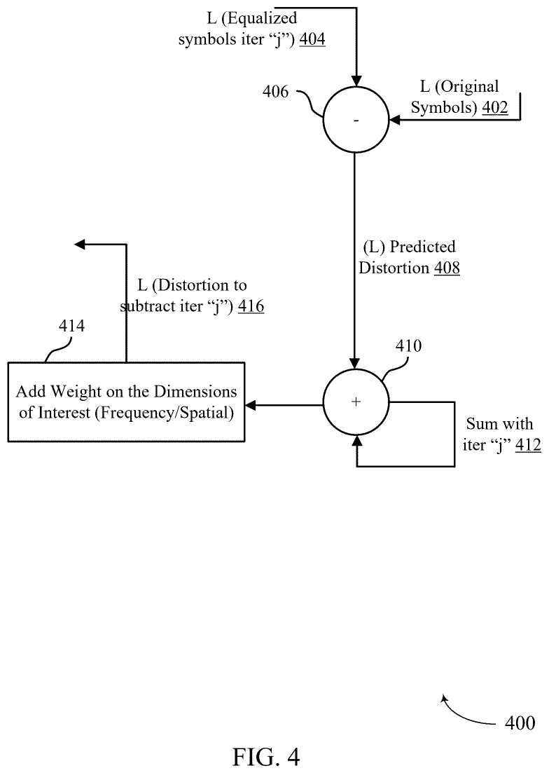

FIG. 4 shows an example of a block diagram 400 that supports techniques for allocating NL distortion to spatial layers in accordance with one or more aspects of the present disclosure. The block diagram 400 may implement aspects of or may be implemented by aspects of the wireless communications system 100 and wireless communications system 200. For example, the block diagram 400 may be implemented by the UE 115-a and the network entity 105-a. The block diagram 400 illustrate aspects of the distortion management block 316 of the block diagram 300.

The distortion management block 316 of the block diagram 300 determines the amount of NL distortion to allocate to each of the layers or other dimensions. The block diagram 400 illustrates an input of the L original symbols 402 from the encoder+mapper block 304 and an input of L equalized symbols of iteration j 404 from the demapper block 332 to a subtracting junction 406, where j is a positive integer. After the subtracting junction 406, the signal is L predicted distortion 408. The input to a summing junction 410 include the L predicted distortion 408 that is summed with the iteration j 412. The output from the summing junction 410 is input to a add weight on the dimension of interest block 414. In some cases, the weighting is from zero to one, and the weighting may indicate the level of NL distortion to allocate to the dimension or subdimension. In some cases, the weighting may be provided by a distortion management matrix, and the distortion management matrix may indicate a weighting factor to apply to a respective dimension of a plurality of dimensions. In some cases, the dimension of interest may be a spatial domain or a frequency domain. The weighting may be viewed as pouring the NL distortion into the different dimension, where the more NL distortion poured into the dimension would contaminate the dimension with the NL distortion. The amount of the allocated or poured distortion may be determined based on a quality associated with a specific dimension. For example, the amount of NL distortion allocated to a specific dimension may depend on a quality of service (QoS), a signal-to-noise ratio (SNR) of the channel, or an interference of the channel. The output of the add weight on the dimension of interest block 414 is L distortion to subtract iteration j 416. Referring to FIG. 2, the distortion management block may allocate or pour the NL distortion to four spatial layers (e.g., layer 1 220, layer 2 225, layer 3 230, and layer 4 235). Each layer or dimension may be allocated a respective NL distortion level 240. The distortion management block may allocate the distortion into the different layers or dimensions, and the NL distortion may vary among the layers in both OOB and EVM. For example, A% of the NL distortion may be allocated to a first layer, B% may be allocated to a second layer, and so forth, where A and B may be numbers that are the same or different. The distortion management block may manage the distortion on the layer domain. The level of NL distortion may be a function of the total NL energy due to the set of NL PAs.

Referring to FIG. 2, the allocation of the NL distortion may be performed by the transmitter device. For cases in which the transmitter is the UE 115-a for transmission of the uplink message 210, the network entity 105-a may indicate how much distortion to allocate or pour per layer, subject to network requirements. For example, the UE 115-a may receive, from the network entity 105-a, a control signal 245 that indicates a distortion management configuration for an uplink transmission by the UE 115-a. In some cases, the distortion management configuration may indicate a plurality of spatial layers to use and may indicate a proportion of NL distortion to allocate a respective spatial layer of the plurality of spatial layers. The network entity 105-a may indicate where in frequency to allocate or pour the NL distortion. For example, the distortion management configuration may indicate one or more frequencies associated with a respective spatial layer of the plurality of spatial layers, and the distortion management configuration may indicate the proportion of NL distortion to allocate to the one or more frequencies. The frequencies may be in-band frequencies with impact on EVM or OOB frequencies, single or dual sided. The distortion management configuration may indicate to allocate the NL distortion on a specific set of frequencies. In some cases, the distortion management configuration indicates a distortion management matrix, and the distortion management matrix indicates a weighting factor to apply to a respective spatial layer of the plurality of spatial layers. For cases in which the transmitter is the network entity 105-a for transmission of the downlink message 205, the network entity 105-a may allocate the NL distortion to the plurality of spatial layers and may allocate the NL distortion to the to the one or more frequencies.

The UE 115-a may receive, from the network entity 105-a, a control message 250 indicating to transmit the uplink message. The UE 115-a may allocate the NL distortion as indicated in the distortion management configuration using the techniques illustrate in FIGS. 3 and 4. The UE 115-a may precode the uplink message to generate a precoded message for transmission via the plurality of spatial layers in accordance with the distortion management configuration. The UE 115-a may transmit, to the network entity 105-a, the precoded message 255 via the plurality of spatial layers.

In some cases, to accommodate the allocation of the NL distortion to spatial layers or other dimensions, performance metrics may be defined per layer or per dimension rather than per port or per transmitter array. For example, the UE 115-a and network entity 105-a may determine a performance metric associated with the precoded message 255, and the performance metric may be determined for the plurality of spatial layers. The performance metric may be an EVM metric or an OOB metric associated with each spatial layer of the plurality of spatial layers or each of the dimensions of the plurality of dimensions.

In some cases, the network entity 105-a may coordinate with the network entity 105-b to control the NL distortion on a specific layer of a specific node connected to the network entity 105-b. For example, the network entity 105-a and the network may send signaling with a request to control the NL distortion on a specific layer of a specific node and to allocate the NL distortion for a specific node. For example, the network entity 105-a may receive, from the network entity 105-b, a control signal 260 that indicates a distortion management configuration associated with one or more spatial layers of a plurality of spatial layers, and second distortion management configuration may indicate, to the network entity 105-a, to apply a NL distortion or to refrain from applying the NL distortion to the one or more spatial layers of the plurality of spatial layers. In some cases, the network entity 105-a may transmit, to the network entity 105-b, a control signal 265 indicating a distortion management configuration associated with one or more spatial layers of the plurality of spatial layers, and the distortion management configuration may indicate, to the network entity 105-b, to apply a NL distortion or to refrain from applying the NL distortion to the one or more spatial layers of the plurality of spatial layers.

In some cases, the receiving device may deliver the MIMO channel to the transmitter device. For example, the UE 115-a may receive, from the network entity 105-a, an indication of a channel matrix for the uplink transmission. The UE 115-a may precode the uplink message based on the channel matrix.

In some cases, the amount of the NL distortion to allocate to the layers may be determined as a function of QoS. For example, the proportion of NL distortion to allocate to a respective spatial layer of the plurality of spatial layers may be based on a quality of service of a data payload of the uplink message. In some cases, the UE 115-a may receive, from the network entity 105-c, a control signal that indicates a quality of service indicator associated with the uplink message, and the proportion of NL distortion to apply to a respective spatial layer of the plurality of spatial layers may be based on the quality of service indicator. In some cases, the network entity 105-c may indicate, to the UE 115-a, to allocate some A% of total NL distortion on layers on which the HARQ retransmissions are sent, while allocating B% of the total NL distortion on the layers on which first transmissions occur (e.g., an initial instance of attempting to send a message in a transmission). The differentiation between the layers may be due to other different reasons, such as the QoS indicator coming from upper layers. In some cases, the amount of the NL distortion to allocate to the layers may be determined as a function of a channel characteristic.

The techniques for allocating NL distortion to spatial layers may use advantages of the multiple input multiple output (MIMO) or multi-TX domain and may introduce a way to allocate or pour the NL distortion into different layers to improve the PA(s) efficiency. The techniques for allocating NL distortion may allow the transmitter device to manage the NL distortion across the spatial layers. The technique may exploit knowledge of the OTA MIMO channel and knowledge of NL model of the PA(s) to (iteratively) be able to control the distortion per layer. The technique may exploit the extra degree of freedom that the NL effect is not the same across transmitter ports at any given instant time and balances this a-symmetry. The techniques allow the transmitter to push the PA(s) to work at noticeably lower values of BO, which boosts the power efficiency. The performance EVM and OOB may be different per layer.

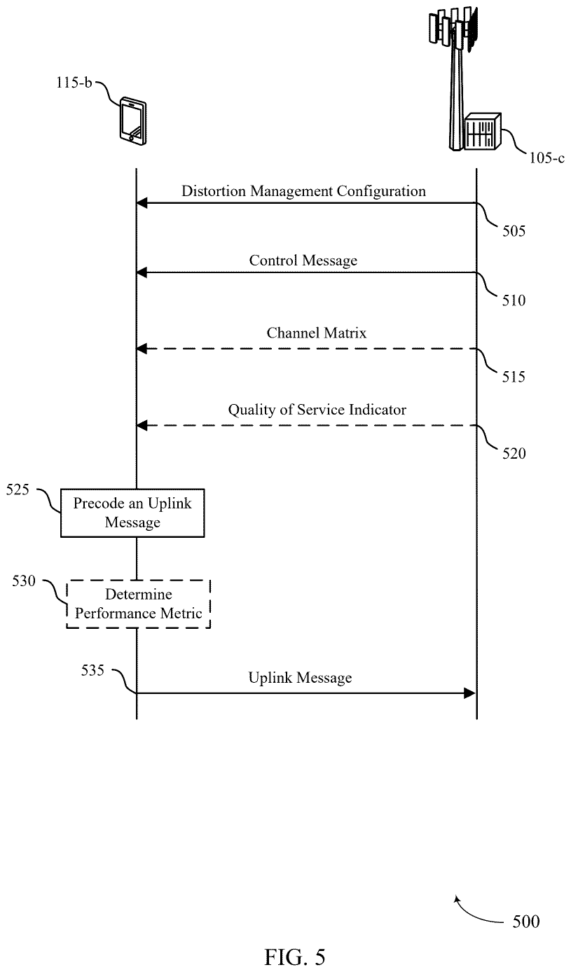

FIG. 5 shows an example of a process flow 500 that supports techniques for allocating NL distortion to spatial layers in accordance with one or more aspects of the present disclosure. The process flow 500 may implement or may be implemented by aspects of the wireless communications system 100 and the wireless communications system 200. For example, the process flow 500 may include a UE 115-b and a network entity 105-c which may be examples of corresponding devices and entities as described with reference to FIGS. 1 and 2. In the following description of the process flow 500, the operations between the UE 115-b and the network entity 105-c may be transmitted in a different order than the example order shown, or the operations performed by the UE 115-b and the network entity 105-c may be performed in different orders or at different times. Some operations may also be omitted from the process flow 500, and other operations may be added to the process flow 500.

At 505, the UE 115-b may receive, from the network entity 105-c, a control signal that indicates a distortion management configuration for an uplink transmission by the UE. The distortion management configuration may indicate a plurality of spatial layers to use, and the distortion management configuration may indicate a proportion of NL distortion to allocate to each spatial layer of the plurality of spatial layers.

In some examples, the distortion management configuration may indicate one or more frequencies associated with each spatial layer of the plurality of spatial layers, and the distortion management configuration may indicate the proportion of NL distortion to allocate to the one or more frequencies. The one or more frequencies may include one or more in-band frequencies or one or more out-of-band frequencies. In some cases, the proportion of NL distortion to allocate to each spatial layer of the plurality of spatial layers may be based on a channel characteristic. In some examples, the distortion management configuration may indicate a distortion management matrix, and the distortion management matrix may indicate a weighting factor to apply to a respective spatial layer of the plurality of spatial layers.

At 510, the UE 115-b may receive, from the network entity 105-c, a control message indicating to transmit an uplink message. In some cases, the proportion of NL distortion to allocate to each spatial layer of the plurality of spatial layers may be based on a quality of service of a data payload of the uplink message.

At 515, the UE 115-b may receive, from the network entity 105-c, an indication of a channel matrix associated with the uplink message.

At 520, the UE 115-b may receive, from the network entity 105-c, a control signal that indicates a quality of service indicator associated with the uplink message. The proportion of NL distortion to allocate to each spatial layer of the plurality of spatial layers may be based on the quality of service indicator.

At 525, the UE 115-b may precode the uplink message to generate a precoded message for transmission via the plurality of spatial layers in accordance with the distortion management configuration. In some examples, the uplink message may be precoded based on the channel matrix.

At 530, the UE 115-b may determine a performance metric associated with the precoded message. In some cases, the performance metric may be determined for the plurality of spatial layers. In some examples, the performance metric may be an error vector magnitude metric or an out-of-band metric associated with each spatial layer of the plurality of spatial layers.

At 535, the UE 115-b may transmit, to the network entity 105-c, the precoded message via the plurality of spatial layers in accordance with the control message.

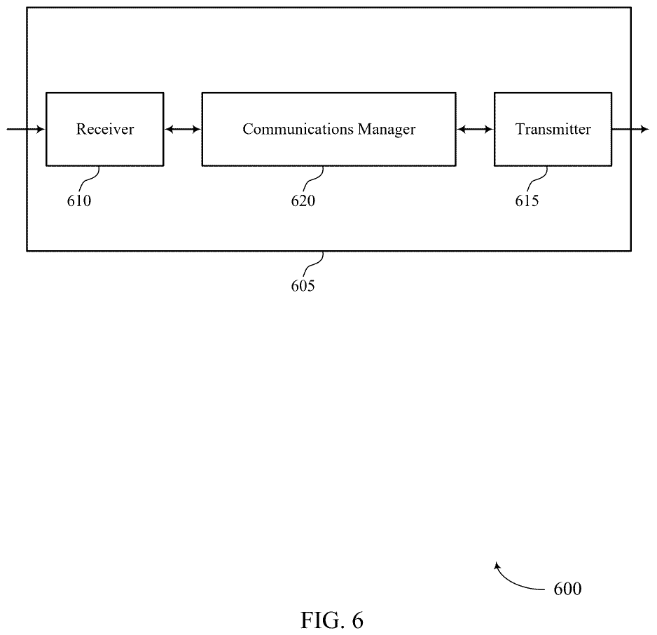

FIG. 6 shows a block diagram 600 of a device 605 that supports techniques for allocating NL distortion to spatial layers in accordance with one or more aspects of the present disclosure. The device 605 may be an example of aspects of a UE 115 as described herein. The device 605 may include a receiver 610, a transmitter 615, and a communications manager 620. The device 605, or one or more components of the device 605 (e.g., the receiver 610, the transmitter 615, the communications manager 620), may include at least one processor, which may be coupled with at least one memory, to, individually or collectively, support or enable the described techniques. Each of these components may be in communication with one another (e.g., via one or more buses).

The receiver 610 may provide a means for receiving information such as packets, user data, control information, or any combination thereof associated with various information channels (e.g., control channels, data channels, information channels related to techniques for allocating NL distortion to spatial layers). Information may be passed on to other components of the device 605. The receiver 610 may utilize a single antenna or a set of multiple antennas.

The transmitter 615 may provide a means for transmitting signals generated by other components of the device 605. For example, the transmitter 615 may transmit information such as packets, user data, control information, or any combination thereof associated with various information channels (e.g., control channels, data channels, information channels related to techniques for allocating NL distortion to spatial layers). In some examples, the transmitter 615 may be co-located with a receiver 610 in a transceiver module. The transmitter 615 may utilize a single antenna or a set of multiple antennas.

The communications manager 620, the receiver 610, the transmitter 615, or various combinations or components thereof may be examples of means for performing various aspects of techniques for allocating NL distortion to spatial layers as described herein. For example, the communications manager 620, the receiver 610, the transmitter 615, or various combinations or components thereof may be capable of performing one or more of the functions described herein.

In some examples, the communications manager 620, the receiver 610, the transmitter 615, or various combinations or components thereof may be implemented in hardware (e.g., in communications management circuitry). The hardware may include at least one of a processor, a digital signal processor (DSP), a central processing unit (CPU), an application-specific integrated circuit (ASIC), a field-programmable gate array (FPGA) or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 620, the receiver 610, the transmitter 615, or various combinations or components thereof may be implemented in code (e.g., as communications management software or firmware) executed by at least one processor (e.g., referred to as a processor-executable code). If implemented in code executed by at least one processor, the functions of the communications manager 620, the receiver 610, the transmitter 615, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 620 may be configured to perform various operations (e.g., receiving, obtaining, monitoring, outputting, transmitting) using or otherwise in cooperation with the receiver 610, the transmitter 615, or both. For example, the communications manager 620 may receive information from the receiver 610, send information to the transmitter 615, or be integrated in combination with the receiver 610, the transmitter 615, or both to obtain information, output information, or perform various other operations as described herein.

The communications manager 620 may support wireless communications in accordance with examples as disclosed herein. For example, the communications manager 620 is capable of, configured to, or operable to support a means for receiving a first control signal that indicates a distortion management configuration for an uplink transmission by the UE, where the distortion management configuration indicates a set of multiple spatial layers to use and indicates a proportion of NL distortion to allocate to each spatial layer of the set of multiple spatial layers. The communications manager 620 is capable of, configured to, or operable to support a means for receiving a control message indicating to transmit an uplink message. The communications manager 620 is capable of, configured to, or operable to support a means for precoding the uplink message to generate a precoded message for transmission via the set of multiple spatial layers in accordance with the distortion management configuration. The communications manager 620 is capable of, configured to, or operable to support a means for transmitting the precoded message via the set of multiple spatial layers in accordance with the control message.

Additionally, or alternatively, the communications manager 620 may support wireless communications in accordance with examples as disclosed herein. For example, the communications manager 620 is capable of, configured to, or operable to support a means for receiving a control message indicating to transmit an uplink message. The communications manager 620 is capable of, configured to, or operable to support a means for precoding the uplink message to generate a precoded message for transmission via a set of multiple spatial layers in accordance with a distortion management configuration, where the distortion management configuration indicates a proportion of NL distortion to allocate to each spatial layer of the set of multiple spatial layers. The communications manager 620 is capable of, configured to, or operable to support a means for transmitting the precoded message via the set of multiple spatial layers in accordance with the distortion management configuration.

By including or configuring the communications manager 620 in accordance with examples as described herein, the device 605 (e.g., at least one processor controlling or otherwise coupled with the receiver 610, the transmitter 615, the communications manager 620, or a combination thereof) may support techniques for more efficient utilization of communication resources.

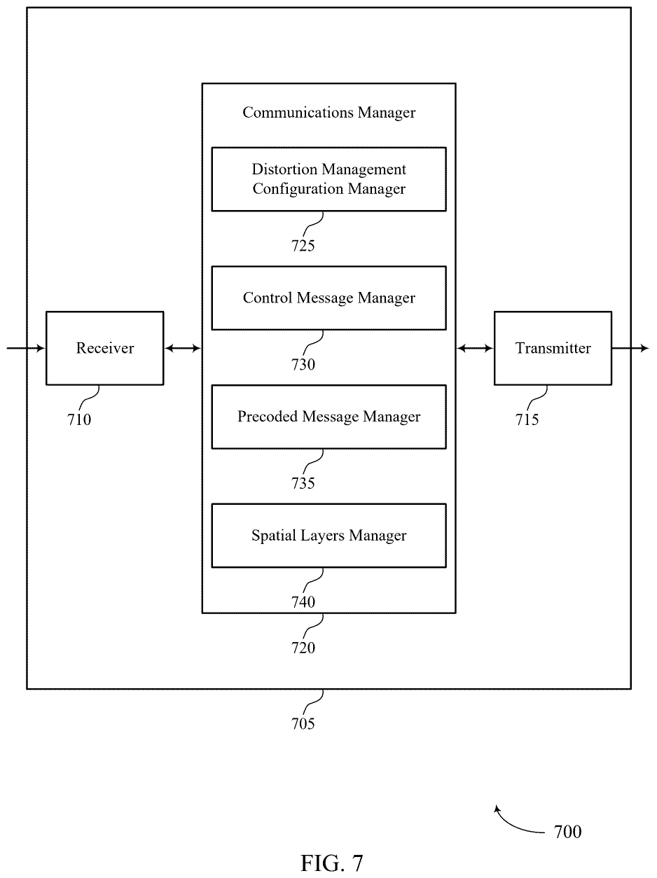

FIG. 7 shows a block diagram 700 of a device 705 that supports techniques for allocating NL distortion to spatial layers in accordance with one or more aspects of the present disclosure. The device 705 may be an example of aspects of a device 605 or a UE 115 as described herein. The device 705 may include a receiver 710, a transmitter 715, and a communications manager 720. The device 705, or one or more components of the device 705 (e.g., the receiver 710, the transmitter 715, the communications manager 720), may include at least one processor, which may be coupled with at least one memory, to support the described techniques. Each of these components may be in communication with one another (e.g., via one or more buses).

The receiver 710 may provide a means for receiving information such as packets, user data, control information, or any combination thereof associated with various information channels (e.g., control channels, data channels, information channels related to techniques for allocating NL distortion to spatial layers). Information may be passed on to other components of the device 705. The receiver 710 may utilize a single antenna or a set of multiple antennas.

The transmitter 715 may provide a means for transmitting signals generated by other components of the device 705. For example, the transmitter 715 may transmit information such as packets, user data, control information, or any combination thereof associated with various information channels (e.g., control channels, data channels, information channels related to techniques for allocating NL distortion to spatial layers). In some examples, the transmitter 715 may be co-located with a receiver 710 in a transceiver module. The transmitter 715 may utilize a single antenna or a set of multiple antennas.

The device 705, or various components thereof, may be an example of means for performing various aspects of techniques for allocating NL distortion to spatial layers as described herein. For example, the communications manager 720 may include a distortion management configuration manager 725, a control message manager 730, a precoded message manager 735, a spatial layers manager 740, or any combination thereof. The communications manager 720 may be an example of aspects of a communications manager 620 as described herein. In some examples, the communications manager 720, or various components thereof, may be configured to perform various operations (e.g., receiving, obtaining, monitoring, outputting, transmitting) using or otherwise in cooperation with the receiver 710, the transmitter 715, or both. For example, the communications manager 720 may receive information from the receiver 710, send information to the transmitter 715, or be integrated in combination with the receiver 710, the transmitter 715, or both to obtain information, output information, or perform various other operations as described herein.

The communications manager 720 may support wireless communications in accordance with examples as disclosed herein. The distortion management configuration manager 725 is capable of, configured to, or operable to support a means for receiving a first control signal that indicates a distortion management configuration for an uplink transmission by the UE, where the distortion management configuration indicates a set of multiple spatial layers to use and indicates a proportion of NL distortion to allocate to each spatial layer of the set of multiple spatial layers. The control message manager 730 is capable of, configured to, or operable to support a means for receiving a control message indicating to transmit an uplink message. The precoded message manager 735 is capable of, configured to, or operable to support a means for precoding the uplink message to generate a precoded message for transmission via the set of multiple spatial layers in accordance with the distortion management configuration. The spatial layers manager 740 is capable of, configured to, or operable to support a means for transmitting the precoded message via the set of multiple spatial layers in accordance with the control message.

Additionally, or alternatively, the communications manager 720 may support wireless communications in accordance with examples as disclosed herein. The control message manager 730 is capable of, configured to, or operable to support a means for receiving a control message indicating to transmit an uplink message. The precoded message manager 735 is capable of, configured to, or operable to support a means for precoding the uplink message to generate a precoded message for transmission via a set of multiple spatial layers in accordance with a distortion management configuration, where the distortion management configuration indicates a proportion of NL distortion to allocate to each spatial layer of the set of multiple spatial layers. The spatial layers manager 740 is capable of, configured to, or operable to support a means for transmitting the precoded message via the set of multiple spatial layers in accordance with the distortion management configuration.

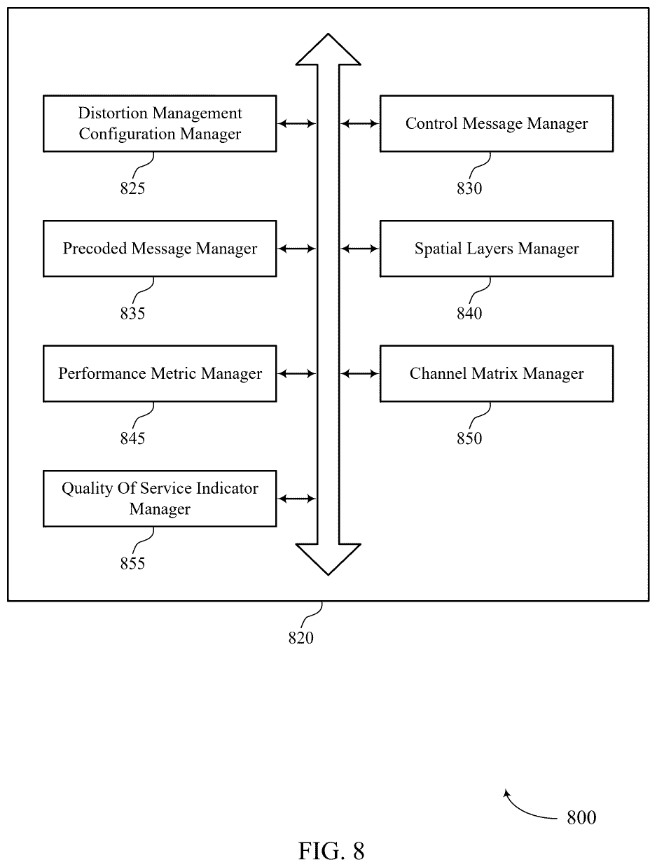

FIG. 8 shows a block diagram 800 of a communications manager 820 that supports techniques for allocating NL distortion to spatial layers in accordance with one or more aspects of the present disclosure. The communications manager 820 may be an example of aspects of a communications manager 620, a communications manager 720, or both, as described herein. The communications manager 820, or various components thereof, may be an example of means for performing various aspects of techniques for allocating NL distortion to spatial layers as described herein. For example, the communications manager 820 may include a distortion management configuration manager 825, a control message manager 830, a precoded message manager 835, a spatial layers manager 840, a performance metric manager 845, a channel matrix manager 850, a quality of service indicator manager 855, or any combination thereof. Each of these components, or components or subcomponents thereof (e.g., one or more processors, one or more memories), may communicate, directly or indirectly, with one another (e.g., via one or more buses).

The communications manager 820 may support wireless communications in accordance with examples as disclosed herein. The distortion management configuration manager 825 is capable of, configured to, or operable to support a means for receiving a first control signal that indicates a distortion management configuration for an uplink transmission by the UE, where the distortion management configuration indicates a set of multiple spatial layers to use and indicates a proportion of NL distortion to allocate to each spatial layer of the set of multiple spatial layers. The control message manager 830 is capable of, configured to, or operable to support a means for receiving a control message indicating to transmit an uplink message. The precoded message manager 835 is capable of, configured to, or operable to support a means for precoding the uplink message to generate a precoded message for transmission via the set of multiple spatial layers in accordance with the distortion management configuration. The spatial layers manager 840 is capable of, configured to, or operable to support a means for transmitting the precoded message via the set of multiple spatial layers in accordance with the control message.

In some examples, the distortion management configuration indicates one or more frequencies associated with each spatial layer of the set of multiple spatial layers, the distortion management configuration indicating the proportion of NL distortion to allocate to the one or more frequencies.

In some examples, the one or more frequencies include one or more in-band frequencies or one or more out-of-band frequencies.

In some examples, the performance metric manager 845 is capable of, configured to, or operable to support a means for determining a performance metric associated with the precoded message, where the performance metric is determined for the set of multiple spatial layers.

In some examples, the performance metric is an error vector magnitude metric or an out-of-band metric associated with each spatial layer of the set of multiple spatial layers.

In some examples, the channel matrix manager 850 is capable of, configured to, or operable to support a means for receiving an indication of a channel matrix associated with the uplink message, where the uplink message is precoded based on the channel matrix.

In some examples, the proportion of NL distortion to allocate to each spatial layer of the set of multiple spatial layers is based on a quality of service of a data payload of the uplink message.

In some examples, the quality of service indicator manager 855 is capable of, configured to, or operable to support a means for receiving a second control signal that indicates a quality of service indicator associated with the uplink message, where the proportion of NL distortion to allocate to each spatial layer of the set of multiple spatial layers is based on the quality of service indicator.

In some examples, the proportion of NL distortion to allocate to each spatial layer of the set of multiple spatial layers is based on a channel characteristic.

Additionally, or alternatively, the communications manager 820 may support wireless communications in accordance with examples as disclosed herein. In some examples, the control message manager 830 is capable of, configured to, or operable to support a means for receiving a control message indicating to transmit an uplink message. In some examples, the precoded message manager 835 is capable of, configured to, or operable to support a means for precoding the uplink message to generate a precoded message for transmission via a set of multiple spatial layers in accordance with a distortion management configuration, where the distortion management configuration indicates a proportion of NL distortion to allocate to each spatial layer of the set of multiple spatial layers. In some examples, the spatial layers manager 840 is capable of, configured to, or operable to support a means for transmitting the precoded message via the set of multiple spatial layers in accordance with the distortion management configuration.

In some examples, the distortion management configuration indicates a distortion management matrix. In some examples, the distortion management matrix indicates a weighting factor to apply to a respective spatial layer of the set of multiple spatial layers.

In some examples, the distortion management configuration indicates one or more frequencies associated with each spatial layer of the set of multiple spatial layers. In some examples, the distortion management configuration indicates the proportion of NL distortion to allocate to the one or more frequencies.

In some examples, the distortion management configuration manager 825 is capable of, configured to, or operable to support a means for receiving a control signal that indicates the distortion management configuration.

In some examples, the distortion management configuration indicates one or more frequencies associated with each spatial layer of the set of multiple spatial layers. In some examples, the distortion management configuration indicates the proportion of NL distortion to allocate to the one or more frequencies.

In some examples, the performance metric manager 845 is capable of, configured to, or operable to support a means for determining a performance metric associated with the precoded message, where the performance metric is determined for the set of multiple spatial layers.

In some examples, the performance metric is an error vector magnitude metric or an out-of-band metric associated with each spatial layer of the set of multiple spatial layers.

In some examples, the channel matrix manager 850 is capable of, configured to, or operable to support a means for receiving an indication of a channel matrix associated with the uplink message, where the uplink message is precoded based on the channel matrix.

In some examples, the proportion of NL distortion to allocate to each spatial layer of the set of multiple spatial layers is based on a quality of service of a data payload of the uplink message.

In some examples, the quality of service indicator manager 855 is capable of, configured to, or operable to support a means for receiving a control signal that indicates a quality of service indicator associated with the uplink message, where the proportion of NL distortion to allocate to each spatial layer of the set of multiple spatial layers is based on the quality of service indicator.

In some examples, the proportion of NL distortion to allocate to each spatial layer of the set of multiple spatial layers is based on a channel characteristic.

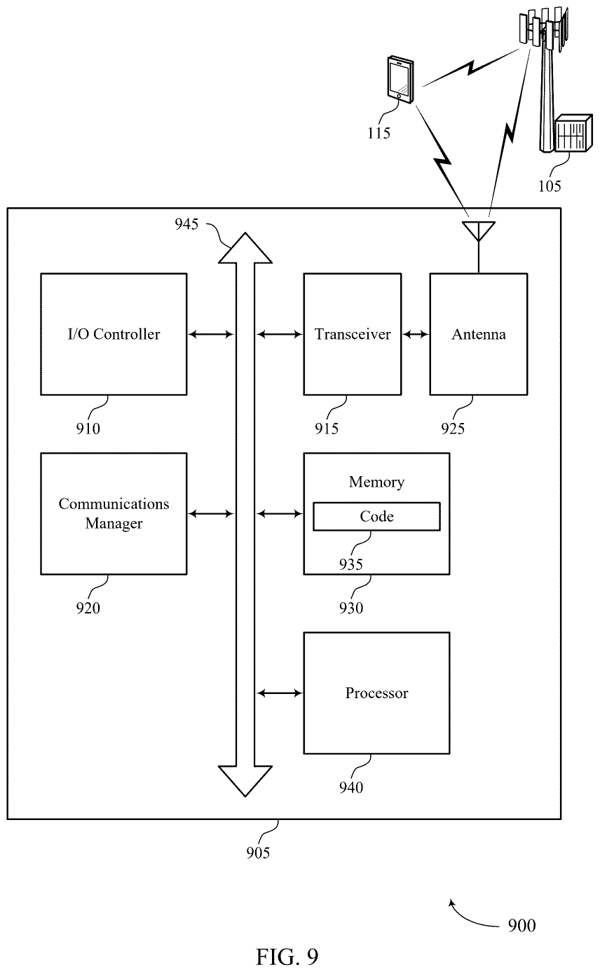

FIG. 9 shows a diagram of a system 900 including a device 905 that supports techniques for allocating NL distortion to spatial layers in accordance with one or more aspects of the present disclosure. The device 905 may be an example of or include components of a device 605, a device 705, or a UE 115 as described herein. The device 905 may communicate (e.g., wirelessly) with one or more other devices (e.g., network entities 105, UEs 115, or a combination thereof). The device 905 may include components for bi-directional voice and data communications including components for transmitting and receiving communications, such as a communications manager 920, an input/output (I/O) controller, such as an I/O controller 910, a transceiver 915, one or more antennas 925, at least one memory 930, code 935, and at least one processor 940. These components may be in electronic communication or otherwise coupled (e.g., operatively, communicatively, functionally, electronically, electrically) via one or more buses (e.g., a bus 945).

The I/O controller 910 may manage input and output signals for the device 905. The I/O controller 910 may also manage peripherals not integrated into the device 905. In some cases, the I/O controller 910 may represent a physical connection or port to an external peripheral. In some cases, the I/O controller 910 may utilize an operating system such as iOS®, ANDROID®, MS-DOS®, MS-WINDOWS®, OS/2®, UNIX®, LINUX®, or another known operating system. Additionally, or alternatively, the I/O controller 910 may represent or interact with a modem, a keyboard, a mouse, a touchscreen, or a similar device. In some cases, the I/O controller 910 may be implemented as part of one or more processors, such as the at least one processor 940. In some cases, a user may interact with the device 905 via the I/O controller 910 or via hardware components controlled by the I/O controller 910.

In some cases, the device 905 may include a single antenna. However, in some other cases, the device 905 may have more than one antenna, which may be capable of concurrently transmitting or receiving multiple wireless transmissions. The transceiver 915 may communicate bi-directionally via the one or more antennas 925 using wired or wireless links as described herein. For example, the transceiver 915 may represent a wireless transceiver and may communicate bi-directionally with another wireless transceiver. The transceiver 915 may also include a modem to modulate the packets, to provide the modulated packets to one or more antennas 925 for transmission, and to demodulate packets received from the one or more antennas 925. The transceiver 915, or the transceiver 915 and one or more antennas 925, may be an example of a transmitter 615, a transmitter 715, a receiver 610, a receiver 710, or any combination thereof or component thereof, as described herein.

The at least one memory 930 may include random access memory (RAM) and read-only memory (ROM). The at least one memory 930 may store computer-readable, computer-executable, or processor-executable code, such as the code 935. The code 935 may include instructions that, when executed by the at least one processor 940, cause the device 905 to perform various functions described herein. The code 935 may be stored in a non-transitory computer-readable medium such as system memory or another type of memory. In some cases, the code 935 may not be directly executable by the at least one processor 940 but may cause a computer (e.g., when compiled and executed) to perform functions described herein. In some cases, the at least one memory 930 may include, among other things, a basic I/O system (BIOS) which may control basic hardware or software operation such as the interaction with peripheral components or devices.

The at least one processor 940 may include one or more intelligent hardware devices (e.g., one or more general-purpose processors, one or more DSPs, one or more CPUs, one or more graphics processing units (GPUs), one or more neural processing units (NPUs) (also referred to as neural network processors or deep learning processors (DLPs)), one or more microcontrollers, one or more ASICs, one or more FPGAs, one or more programmable logic devices, discrete gate or transistor logic, one or more discrete hardware components, or any combination thereof). In some cases, the at least one processor 940 may be configured to operate a memory array using a memory controller. In some other cases, a memory controller may be integrated into the at least one processor 940. The at least one processor 940 may be configured to execute computer-readable instructions stored in a memory (e.g., the at least one memory 930) to cause the device 905 to perform various functions (e.g., functions or tasks supporting techniques for allocating NL distortion to spatial layers). For example, the device 905 or a component of the device 905 may include at least one processor 940 and at least one memory 930 coupled with or to the at least one processor 940, the at least one processor 940 and the at least one memory 930 configured to perform various functions described herein.

In some examples, the at least one processor 940 may include multiple processors and the at least one memory 930 may include multiple memories. One or more of the multiple processors may be coupled with one or more of the multiple memories, which may, individually or collectively, be configured to perform various functions described herein. In some examples, the at least one processor 940 may be a component of a processing system, which may refer to a system (such as a series) of machines, circuitry (including, for example, one or both of processor circuitry (which may include the at least one processor 940) and memory circuitry (which may include the at least one memory 930)), or components, that receives or obtains inputs and processes the inputs to produce, generate, or obtain a set of outputs. The processing system may be configured to perform one or more of the functions described herein. For example, the at least one processor 940 or a processing system including the at least one processor 940 may be configured to, configurable to, or operable to cause the device 905 to perform one or more of the functions described herein. Further, as described herein, being “configured to,” being “configurable to,” and being “operable to” may be used interchangeably and may be associated with a capability, when executing code 935 (e.g., processor-executable code) stored in the at least one memory 930 or otherwise, to perform one or more of the functions described herein.

The communications manager 920 may support wireless communications in accordance with examples as disclosed herein. For example, the communications manager 920 is capable of, configured to, or operable to support a means for receiving a first control signal that indicates a distortion management configuration for an uplink transmission by the UE, where the distortion management configuration indicates a set of multiple spatial layers to use and indicates a proportion of NL distortion to allocate to each spatial layer of the set of multiple spatial layers. The communications manager 920 is capable of, configured to, or operable to support a means for receiving a control message indicating to transmit an uplink message. The communications manager 920 is capable of, configured to, or operable to support a means for precoding the uplink message to generate a precoded message for transmission via the set of multiple spatial layers in accordance with the distortion management configuration. The communications manager 920 is capable of, configured to, or operable to support a means for transmitting the precoded message via the set of multiple spatial layers in accordance with the control message.

Additionally, or alternatively, the communications manager 920 may support wireless communications in accordance with examples as disclosed herein. For example, the communications manager 920 is capable of, configured to, or operable to support a means for receiving a control message indicating to transmit an uplink message. The communications manager 920 is capable of, configured to, or operable to support a means for precoding the uplink message to generate a precoded message for transmission via a set of multiple spatial layers in accordance with a distortion management configuration, where the distortion management configuration indicates a proportion of NL distortion to allocate to each spatial layer of the set of multiple spatial layers. The communications manager 920 is capable of, configured to, or operable to support a means for transmitting the precoded message via the set of multiple spatial layers in accordance with the distortion management configuration.

By including or configuring the communications manager 920 in accordance with examples as described herein, the device 905 may support techniques for improved communication reliability, more efficient utilization of communication resources, and improved coordination between devices.

In some examples, the communications manager 920 may be configured to perform various operations (e.g., receiving, monitoring, transmitting) using or otherwise in cooperation with the transceiver 915, the one or more antennas 925, or any combination thereof. Although the communications manager 920 is illustrated as a separate component, in some examples, one or more functions described with reference to the communications manager 920 may be supported by or performed by the at least one processor 940, the at least one memory 930, the code 935, or any combination thereof. For example, the code 935 may include instructions executable by the at least one processor 940 to cause the device 905 to perform various aspects of techniques for allocating NL distortion to spatial layers as described herein, or the at least one processor 940 and the at least one memory 930 may be otherwise configured to, individually or collectively, perform or support such operations.

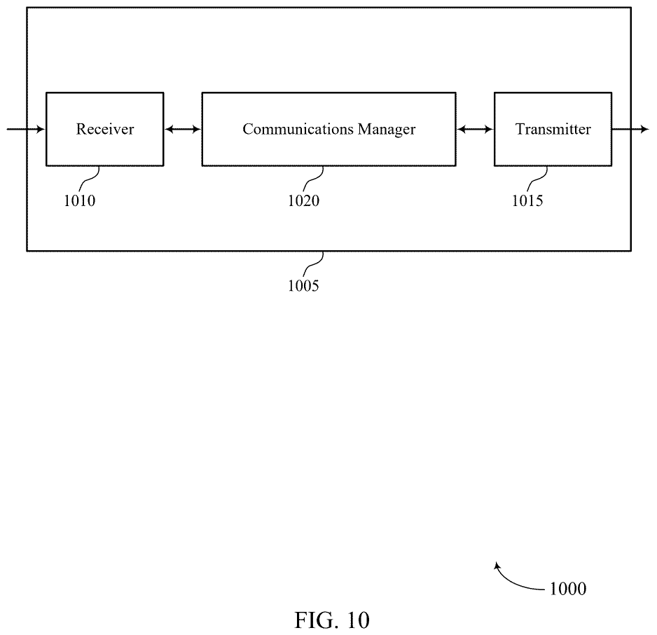

FIG. 10 shows a block diagram 1000 of a device 1005 that supports techniques for allocating NL distortion to spatial layers in accordance with one or more aspects of the present disclosure. The device 1005 may be an example of aspects of a network entity 105 as described herein. The device 1005 may include a receiver 1010, a transmitter 1015, and a communications manager 1020. The device 1005, or one or more components of the device 1005 (e.g., the receiver 1010, the transmitter 1015, the communications manager 1020), may include at least one processor, which may be coupled with at least one memory, to, individually or collectively, support or enable the described techniques. Each of these components may be in communication with one another (e.g., via one or more buses).

The receiver 1010 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1005. In some examples, the receiver 1010 may support obtaining information by receiving signals via one or more antennas. Additionally, or alternatively, the receiver 1010 may support obtaining information by receiving signals via one or more wired (e.g., electrical, fiber optic) interfaces, wireless interfaces, or any combination thereof.

The transmitter 1015 may provide a means for outputting (e.g., transmitting, providing, conveying, sending) information generated by other components of the device 1005. For example, the transmitter 1015 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 1015 may support outputting information by transmitting signals via one or more antennas. Additionally, or alternatively, the transmitter 1015 may support outputting information by transmitting signals via one or more wired (e.g., electrical, fiber optic) interfaces, wireless interfaces, or any combination thereof. In some examples, the transmitter 1015 and the receiver 1010 may be co-located in a transceiver, which may include or be coupled with a modem.

The communications manager 1020, the receiver 1010, the transmitter 1015, or various combinations or components thereof may be examples of means for performing various aspects of techniques for allocating NL distortion to spatial layers as described herein. For example, the communications manager 1020, the receiver 1010, the transmitter 1015, or various combinations or components thereof may be capable of performing one or more of the functions described herein.

In some examples, the communications manager 1020, the receiver 1010, the transmitter 1015, or various combinations or components thereof may be implemented in hardware (e.g., in communications management circuitry). The hardware may include at least one of a processor, a DSP, a CPU, an ASIC, an FPGA or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 1020, the receiver 1010, the transmitter 1015, or various combinations or components thereof may be implemented in code (e.g., as communications management software or firmware) executed by at least one processor (e.g., referred to as a processor-executable code). If implemented in code executed by at least one processor, the functions of the communications manager 1020, the receiver 1010, the transmitter 1015, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 1020 may be configured to perform various operations (e.g., receiving, obtaining, monitoring, outputting, transmitting) using or otherwise in cooperation with the receiver 1010, the transmitter 1015, or both. For example, the communications manager 1020 may receive information from the receiver 1010, send information to the transmitter 1015, or be integrated in combination with the receiver 1010, the transmitter 1015, or both to obtain information, output information, or perform various other operations as described herein.

The communications manager 1020 may support wireless communications in accordance with examples as disclosed herein. For example, the communications manager 1020 is capable of, configured to, or operable to support a means for outputting, to a UE, a first control signal that indicates a first distortion management configuration for an uplink transmission by the UE, where the first distortion management configuration indicates a set of multiple spatial layers to use and indicates a proportion of NL distortion to allocate to each spatial layer of the set of multiple spatial layers. The communications manager 1020 is capable of, configured to, or operable to support a means for outputting, to the UE, a control message indicating that the UE is to transmit an uplink message. The communications manager 1020 is capable of, configured to, or operable to support a means for obtaining, from the UE, the uplink message via the set of multiple spatial layers in accordance with the control message and the first distortion management configuration.

By including or configuring the communications manager 1020 in accordance with examples as described herein, the device 1005 (e.g., at least one processor controlling or otherwise coupled with the receiver 1010, the transmitter 1015, the communications manager 1020, or a combination thereof) may support techniques for more efficient utilization of communication resources.

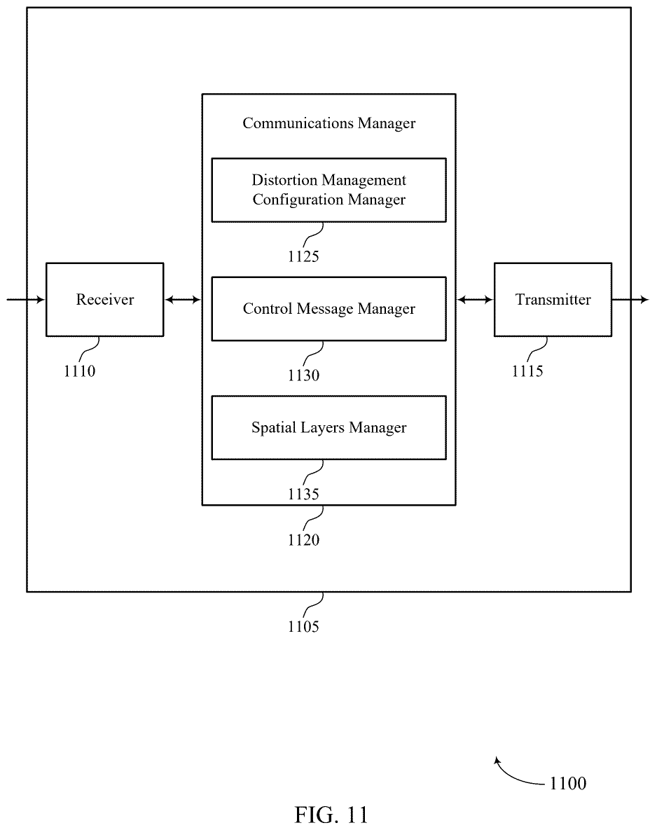

FIG. 11 shows a block diagram 1100 of a device 1105 that supports techniques for allocating NL distortion to spatial layers in accordance with one or more aspects of the present disclosure. The device 1105 may be an example of aspects of a device 1005 or a network entity 105 as described herein. The device 1105 may include a receiver 1110, a transmitter 1115, and a communications manager 1120. The device 1105, or one or more components of the device 1105 (e.g., the receiver 1110, the transmitter 1115, the communications manager 1120), may include at least one processor, which may be coupled with at least one memory, to support the described techniques. Each of these components may be in communication with one another (e.g., via one or more buses).

The receiver 1110 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1105. In some examples, the receiver 1110 may support obtaining information by receiving signals via one or more antennas. Additionally, or alternatively, the receiver 1110 may support obtaining information by receiving signals via one or more wired (e.g., electrical, fiber optic) interfaces, wireless interfaces, or any combination thereof.

The transmitter 1115 may provide a means for outputting (e.g., transmitting, providing, conveying, sending) information generated by other components of the device 1105. For example, the transmitter 1115 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 1115 may support outputting information by transmitting signals via one or more antennas. Additionally, or alternatively, the transmitter 1115 may support outputting information by transmitting signals via one or more wired (e.g., electrical, fiber optic) interfaces, wireless interfaces, or any combination thereof. In some examples, the transmitter 1115 and the receiver 1110 may be co-located in a transceiver, which may include or be coupled with a modem.

The device 1105, or various components thereof, may be an example of means for performing various aspects of techniques for allocating NL distortion to spatial layers as described herein. For example, the communications manager 1120 may include a distortion management configuration manager 1125, a control message manager 1130, a spatial layers manager 1135, or any combination thereof. The communications manager 1120 may be an example of aspects of a communications manager 1020 as described herein. In some examples, the communications manager 1120, or various components thereof, may be configured to perform various operations (e.g., receiving, obtaining, monitoring, outputting, transmitting) using or otherwise in cooperation with the receiver 1110, the transmitter 1115, or both. For example, the communications manager 1120 may receive information from the receiver 1110, send information to the transmitter 1115, or be integrated in combination with the receiver 1110, the transmitter 1115, or both to obtain information, output information, or perform various other operations as described herein.

The communications manager 1120 may support wireless communications in accordance with examples as disclosed herein. The distortion management configuration manager 1125 is capable of, configured to, or operable to support a means for outputting, to a UE, a first control signal that indicates a first distortion management configuration for an uplink transmission by the UE, where the first distortion management configuration indicates a set of multiple spatial layers to use and indicates a proportion of NL distortion to allocate to each spatial layer of the set of multiple spatial layers. The control message manager 1130 is capable of, configured to, or operable to support a means for outputting, to the UE, a control message indicating that the UE is to transmit an uplink message. The spatial layers manager 1135 is capable of, configured to, or operable to support a means for obtaining, from the UE, the uplink message via the set of multiple spatial layers in accordance with the control message and the first distortion management configuration.

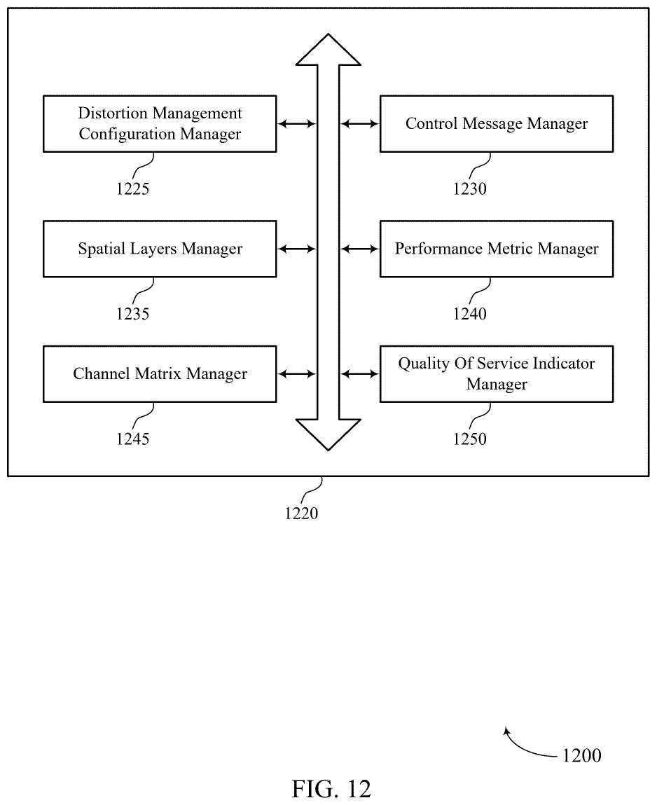

FIG. 12 shows a block diagram 1200 of a communications manager 1220 that supports techniques for allocating NL distortion to spatial layers in accordance with one or more aspects of the present disclosure. The communications manager 1220 may be an example of aspects of a communications manager 1020, a communications manager 1120, or both, as described herein. The communications manager 1220, or various components thereof, may be an example of means for performing various aspects of techniques for allocating NL distortion to spatial layers as described herein. For example, the communications manager 1220 may include a distortion management configuration manager 1225, a control message manager 1230, a spatial layers manager 1235, a performance metric manager 1240, a channel matrix manager 1245, a quality of service indicator manager 1250, or any combination thereof. Each of these components, or components or subcomponents thereof (e.g., one or more processors, one or more memories), may communicate, directly or indirectly, with one another (e.g., via one or more buses). The communications may include communications within a protocol layer of a protocol stack, communications associated with a logical channel of a protocol stack (e.g., between protocol layers of a protocol stack, within a device, component, or virtualized component associated with a network entity 105, between devices, components, or virtualized components associated with a network entity 105), or any combination thereof.

The communications manager 1220 may support wireless communications in accordance with examples as disclosed herein. The distortion management configuration manager 1225 is capable of, configured to, or operable to support a means for outputting, to a UE, a first control signal that indicates a first distortion management configuration for an uplink transmission by the UE, where the first distortion management configuration indicates a set of multiple spatial layers to use and indicates a proportion of NL distortion to allocate to each spatial layer of the set of multiple spatial layers. The control message manager 1230 is capable of, configured to, or operable to support a means for outputting, to the UE, a control message indicating that the UE is to transmit an uplink message. The spatial layers manager 1235 is capable of, configured to, or operable to support a means for obtaining, from the UE, the uplink message via the set of multiple spatial layers in accordance with the control message and the first distortion management configuration.

In some examples, the first distortion management configuration indicates one or more frequencies associated with each spatial layer of the set of multiple spatial layers. In some examples, the first distortion management configuration indicating the proportion of NL distortion to allocate to the one or more frequencies.

In some examples, the one or more frequencies include one or more in-band frequencies or one or more out-of-band frequencies.

In some examples, the performance metric manager 1240 is capable of, configured to, or operable to support a means for determining a performance metric associated with the uplink message, where the performance metric is determined for the set of multiple spatial layers.

In some examples, the performance metric is an error vector magnitude metric or an out-of-band metric associated with each spatial layer of the set of multiple spatial layers.

In some examples, the distortion management configuration manager 1225 is capable of, configured to, or operable to support a means for obtaining, from a second network entity, a second control signal indicating a second distortion management configuration associated with one or more spatial layers of the set of multiple spatial layers, where the second distortion management configuration indicates to allocate a NL distortion or to refrain from allocating the NL distortion to the one or more spatial layers of the set of multiple spatial layers.

In some examples, the distortion management configuration manager 1225 is capable of, configured to, or operable to support a means for outputting, to a second network entity, a second control signal indicating a second distortion management configuration associated with one or more spatial layers of the set of multiple spatial layers, where the second distortion management configuration indicates to allocate a NL distortion or to refrain from allocating the NL distortion to the one or more spatial layers of the set of multiple spatial layers.

In some examples, the channel matrix manager 1245 is capable of, configured to, or operable to support a means for outputting an indication of a channel matrix associated with the uplink message.

In some examples, the proportion of NL distortion to allocate to each spatial layer of the set of multiple spatial layers is based on a quality of service of a data payload of the uplink message.

In some examples, the quality of service indicator manager 1250 is capable of, configured to, or operable to support a means for outputting, to the UE, a second control signal that indicates a quality of service indicator associated with the uplink message, where the proportion of NL distortion to allocate to each spatial layer of the set of multiple spatial layers is based on the quality of service indicator.

In some examples, the proportion of NL distortion to allocate to each spatial layer of the set of multiple spatial layers is based on a channel characteristic.

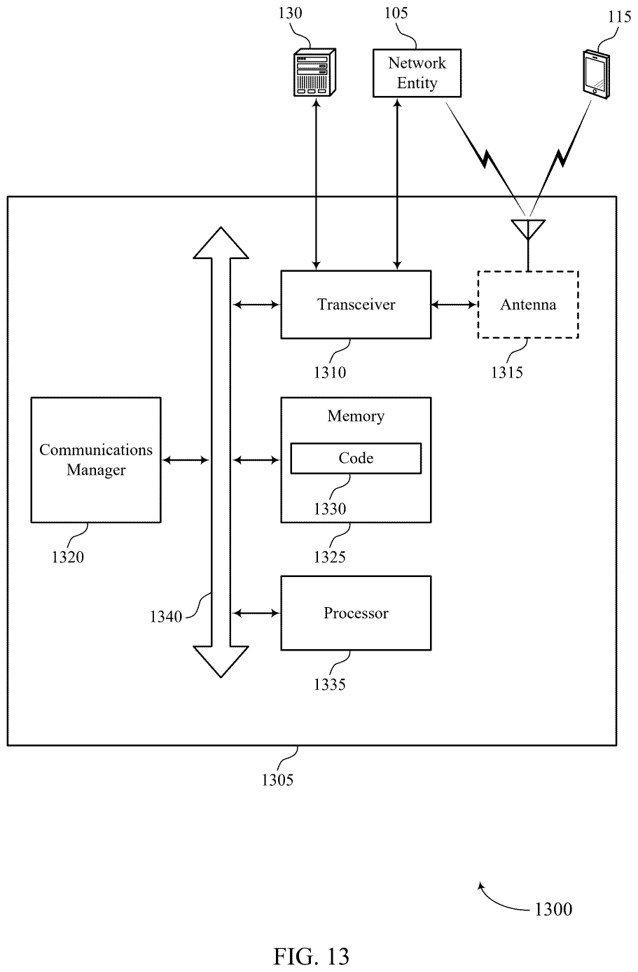

FIG. 13 shows a diagram of a system 1300 including a device 1305 that supports techniques for allocating NL distortion to spatial layers in accordance with one or more aspects of the present disclosure. The device 1305 may be an example of or include components of a device 1005, a device 1105, or a network entity 105 as described herein. The device 1305 may communicate with other network devices or network equipment such as one or more of the network entities 105, UEs 115, or any combination thereof. The communications may include communications over one or more wired interfaces, over one or more wireless interfaces, or any combination thereof. The device 1305 may include components that support outputting and obtaining communications, such as a communications manager 1320, a transceiver 1310, one or more antennas 1315, at least one memory 1325, code 1330, and at least one processor 1335. These components may be in electronic communication or otherwise coupled (e.g., operatively, communicatively, functionally, electronically, electrically) via one or more buses (e.g., a bus 1340).

The transceiver 1310 may support bi-directional communications via wired links, wireless links, or both as described herein. In some examples, the transceiver 1310 may include a wired transceiver and may communicate bi-directionally with another wired transceiver. Additionally, or alternatively, in some examples, the transceiver 1310 may include a wireless transceiver and may communicate bi-directionally with another wireless transceiver. In some examples, the device 1305 may include one or more antennas 1315, which may be capable of transmitting or receiving wireless transmissions (e.g., concurrently). The transceiver 1310 may also include a modem to modulate signals, to provide the modulated signals for transmission (e.g., by one or more antennas 1315, by a wired transmitter), to receive modulated signals (e.g., from one or more antennas 1315, from a wired receiver), and to demodulate signals. In some implementations, the transceiver 1310 may include one or more interfaces, such as one or more interfaces coupled with the one or more antennas 1315 that are configured to support various receiving or obtaining operations, or one or more interfaces coupled with the one or more antennas 1315 that are configured to support various transmitting or outputting operations, or a combination thereof. In some implementations, the transceiver 1310 may include or be configured for coupling with one or more processors or one or more memory components that are operable to perform or support operations based on received or obtained information or signals, or to generate information or other signals for transmission or other outputting, or any combination thereof. In some implementations, the transceiver 1310, or the transceiver 1310 and the one or more antennas 1315, or the transceiver 1310 and the one or more antennas 1315 and one or more processors or one or more memory components (e.g., the at least one processor 1335, the at least one memory 1325, or both), may be included in a chip or chip assembly that is installed in the device 1305. In some examples, the transceiver 1310 may be operable to support communications via one or more communications links (e.g., communication link(s) 125, backhaul communication link(s) 120, a midhaul communication link 162, a fronthaul communication link 168).

The at least one memory 1325 may include RAM, ROM, or any combination thereof. The at least one memory 1325 may store computer-readable, computer-executable, or processor-executable code, such as the code 1330. The code 1330 may include instructions that, when executed by one or more of the at least one processor 1335, cause the device 1305 to perform various functions described herein. The code 1330 may be stored in a non-transitory computer-readable medium such as system memory or another type of memory. In some cases, the code 1330 may not be directly executable by a processor of the at least one processor 1335 but may cause a computer (e.g., when compiled and executed) to perform functions described herein. In some cases, the at least one memory 1325 may include, among other things, a BIOS which may control basic hardware or software operation such as the interaction with peripheral components or devices. In some examples, the at least one processor 1335 may include multiple processors and the at least one memory 1325 may include multiple memories. One or more of the multiple processors may be coupled with one or more of the multiple memories which may, individually or collectively, be configured to perform various functions herein (for example, as part of a processing system).

The at least one processor 1335 may include one or more intelligent hardware devices (e.g., one or more general-purpose processors, one or more DSPs, one or more CPUs, one or more graphics processing units (GPUs), one or more neural processing units (NPUs) (also referred to as neural network processors or deep learning processors (DLPs)), one or more microcontrollers, one or more ASICs, one or more FPGAs, one or more programmable logic devices, discrete gate or transistor logic, one or more discrete hardware components, or any combination thereof). In some cases, the at least one processor 1335 may be configured to operate a memory array using a memory controller. In some other cases, a memory controller may be integrated into one or more of the at least one processor 1335. The at least one processor 1335 may be configured to execute computer-readable instructions stored in a memory (e.g., one or more of the at least one memory 1325) to cause the device 1305 to perform various functions (e.g., functions or tasks supporting techniques for allocating NL distortion to spatial layers). For example, the device 1305 or a component of the device 1305 may include at least one processor 1335 and at least one memory 1325 coupled with one or more of the at least one processor 1335, the at least one processor 1335 and the at least one memory 1325 configured to perform various functions described herein. The at least one processor 1335 may be an example of a cloud-computing platform (e.g., one or more physical nodes and supporting software such as operating systems, virtual machines, or container instances) that may host the functions (e.g., by executing code 1330) to perform the functions of the device 1305. The at least one processor 1335 may be any one or more suitable processors capable of executing scripts or instructions of one or more software programs stored in the device 1305 (such as within one or more of the at least one memory 1325).

In some examples, the at least one processor 1335 may include multiple processors and the at least one memory 1325 may include multiple memories. One or more of the multiple processors may be coupled with one or more of the multiple memories, which may, individually or collectively, be configured to perform various functions herein. In some examples, the at least one processor 1335 may be a component of a processing system, which may refer to a system (such as a series) of machines, circuitry (including, for example, one or both of processor circuitry (which may include the at least one processor 1335) and memory circuitry (which may include the at least one memory 1325)), or components, that receives or obtains inputs and processes the inputs to produce, generate, or obtain a set of outputs. The processing system may be configured to perform one or more of the functions described herein. For example, the at least one processor 1335 or a processing system including the at least one processor 1335 may be configured to, configurable to, or operable to cause the device 1305 to perform one or more of the functions described herein. Further, as described herein, being “configured to,” being “configurable to,” and being “operable to” may be used interchangeably and may be associated with a capability, when executing code stored in the at least one memory 1325 or otherwise, to perform one or more of the functions described herein.

In some examples, a bus 1340 may support communications of (e.g., within) a protocol layer of a protocol stack. In some examples, a bus 1340 may support communications associated with a logical channel of a protocol stack (e.g., between protocol layers of a protocol stack), which may include communications performed within a component of the device 1305, or between different components of the device 1305 that may be co-located or located in different locations (e.g., where the device 1305 may refer to a system in which one or more of the communications manager 1320, the transceiver 1310, the at least one memory 1325, the code 1330, and the at least one processor 1335 may be located in one of the different components or divided between different components).

In some examples, the communications manager 1320 may manage aspects of communications with a core network 130 (e.g., via one or more wired or wireless backhaul links). For example, the communications manager 1320 may manage the transfer of data communications for client devices, such as one or more UEs 115. In some examples, the communications manager 1320 may manage communications with one or more other network entities 105, and may include a controller or scheduler for controlling communications with UEs 115 (e.g., in cooperation with the one or more other network devices). In some examples, the communications manager 1320 may support an X2 interface within an LTE/LTE-A wireless communications network technology to provide communication between network entities 105.

The communications manager 1320 may support wireless communications in accordance with examples as disclosed herein. For example, the communications manager 1320 is capable of, configured to, or operable to support a means for outputting, to a UE, a first control signal that indicates a first distortion management configuration for an uplink transmission by the UE, where the first distortion management configuration indicates a set of multiple spatial layers to use and indicates a proportion of NL distortion to allocate to each spatial layer of the set of multiple spatial layers. The communications manager 1320 is capable of, configured to, or operable to support a means for outputting, to the UE, a control message indicating that the UE is to transmit an uplink message. The communications manager 1320 is capable of, configured to, or operable to support a means for obtaining, from the UE, the uplink message via the set of multiple spatial layers in accordance with the control message and the first distortion management configuration.

By including or configuring the communications manager 1320 in accordance with examples as described herein, the device 1305 may support techniques for improved communication reliability, more efficient utilization of communication resources, and improved coordination between devices.

In some examples, the communications manager 1320 may be configured to perform various operations (e.g., receiving, obtaining, monitoring, outputting, transmitting) using or otherwise in cooperation with the transceiver 1310, the one or more antennas 1315 (e.g., where applicable), or any combination thereof. Although the communications manager 1320 is illustrated as a separate component, in some examples, one or more functions described with reference to the communications manager 1320 may be supported by or performed by the transceiver 1310, one or more of the at least one processor 1335, one or more of the at least one memory 1325, the code 1330, or any combination thereof (for example, by a processing system including at least a portion of the at least one processor 1335, the at least one memory 1325, the code 1330, or any combination thereof). For example, the code 1330 may include instructions executable by one or more of the at least one processor 1335 to cause the device 1305 to perform various aspects of techniques for allocating NL distortion to spatial layers as described herein, or the at least one processor 1335 and the at least one memory 1325 may be otherwise configured to, individually or collectively, perform or support such operations.

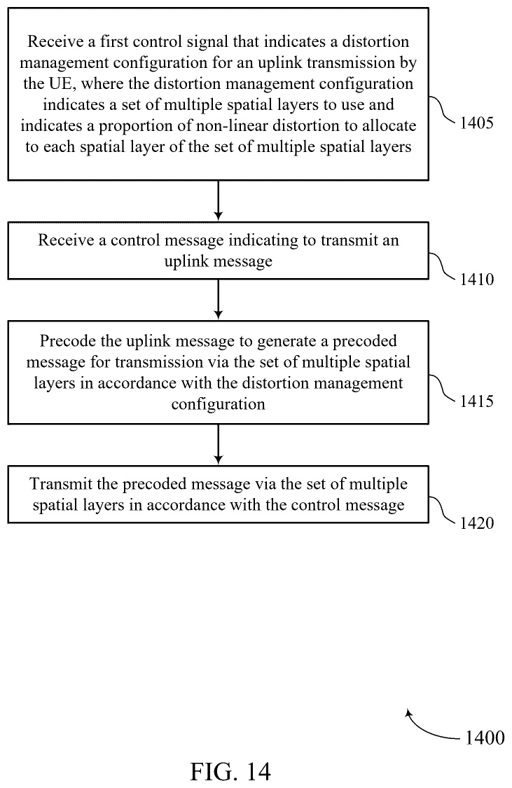

FIG. 14 shows a flowchart illustrating a method 1400 that supports techniques for allocating NL distortion to spatial layers in accordance with one or more aspects of the present disclosure. The operations of the method 1400 may be implemented by a UE or its components as described herein. For example, the operations of the method 1400 may be performed by a UE 115 as described with reference to FIGS. 1 through 9. In some examples, a UE may execute a set of instructions to control the functional elements of the UE to perform the described functions. Additionally, or alternatively, the UE may perform aspects of the described functions using special-purpose hardware.

At 1405, the method may include receiving a first control signal that indicates a distortion management configuration for an uplink transmission by the UE, where the distortion management configuration indicates a set of multiple spatial layers to use and indicates a proportion of NL distortion to allocate to each spatial layer of the set of multiple spatial layers. The operations of 1405 may be performed in accordance with examples as disclosed herein. In some examples, aspects of the operations of 1405 may be performed by a distortion management configuration manager 825 as described with reference to FIG. 8.

At 1410, the method may include receiving a control message indicating to transmit an uplink message. The operations of 1410 may be performed in accordance with examples as disclosed herein. In some examples, aspects of the operations of 1410 may be performed by a control message manager 830 as described with reference to FIG. 8.

At 1415, the method may include precoding the uplink message to generate a precoded message for transmission via the set of multiple spatial layers in accordance with the distortion management configuration. The operations of 1415 may be performed in accordance with examples as disclosed herein. In some examples, aspects of the operations of 1415 may be performed by a precoded message manager 835 as described with reference to FIG. 8.

At 1420, the method may include transmitting the precoded message via the set of multiple spatial layers in accordance with the control message. The operations of 1420 may be performed in accordance with examples as disclosed herein. In some examples, aspects of the operations of 1420 may be performed by a spatial layers manager 840 as described with reference to FIG. 8.

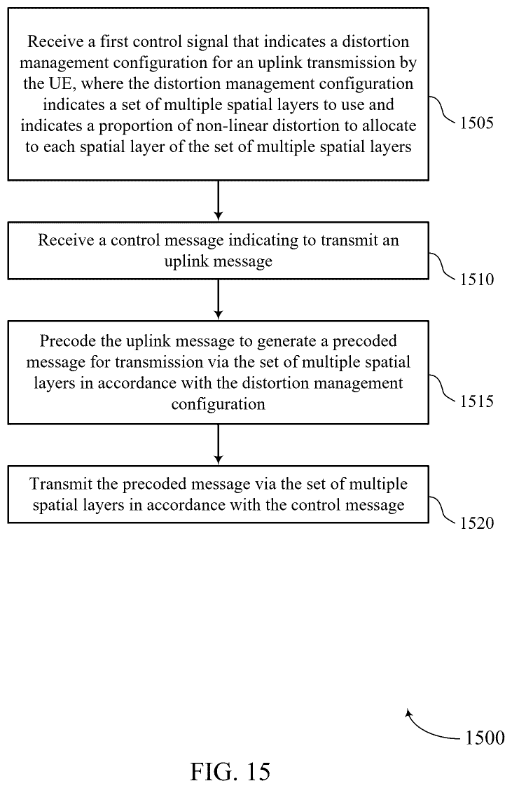

FIG. 15 shows a flowchart illustrating a method 1500 that supports techniques for allocating NL distortion to spatial layers in accordance with one or more aspects of the present disclosure. The operations of the method 1500 may be implemented by a UE or its components as described herein. For example, the operations of the method 1500 may be performed by a UE 115 as described with reference to FIGS. 1 through 9. In some examples, a UE may execute a set of instructions to control the functional elements of the UE to perform the described functions. Additionally, or alternatively, the UE may perform aspects of the described functions using special-purpose hardware.

At 1505, the method may include receiving a first control signal that indicates a distortion management configuration for an uplink transmission by the UE, where the distortion management configuration indicates a set of multiple spatial layers to use and indicates a proportion of NL distortion to allocate to each spatial layer of the set of multiple spatial layers. The operations of 1505 may be performed in accordance with examples as disclosed herein. In some examples, aspects of the operations of 1505 may be performed by a distortion management configuration manager 825 as described with reference to FIG. 8.

At 1510, the method may include receiving a control message indicating to transmit an uplink message. The operations of 1510 may be performed in accordance with examples as disclosed herein. In some examples, aspects of the operations of 1510 may be performed by a control message manager 830 as described with reference to FIG. 8.

At 1515, the method may include precoding the uplink message to generate a precoded message for transmission via the set of multiple spatial layers in accordance with the distortion management configuration. The operations of 1515 may be performed in accordance with examples as disclosed herein. In some examples, aspects of the operations of 1515 may be performed by a precoded message manager 835 as described with reference to FIG. 8.

At 1520, the method may include transmitting the precoded message via the set of multiple spatial layers in accordance with the control message. The operations of 1520 may be performed in accordance with examples as disclosed herein. In some examples, aspects of the operations of 1520 may be performed by a spatial layers manager 840 as described with reference to FIG. 8.

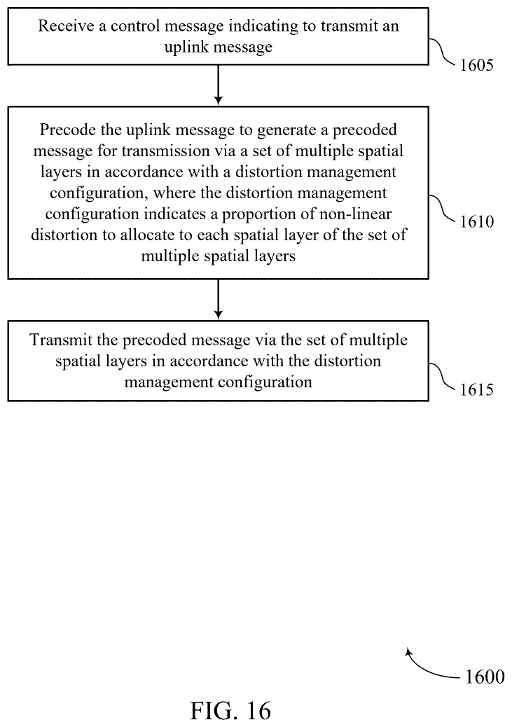

FIG. 16 shows a flowchart illustrating a method 1600 that supports techniques for allocating NL distortion to spatial layers in accordance with one or more aspects of the present disclosure. The operations of the method 1600 may be implemented by a UE or its components as described herein. For example, the operations of the method 1600 may be performed by a UE 115 as described with reference to FIGS. 1 through 9. In some examples, a UE may execute a set of instructions to control the functional elements of the UE to perform the described functions. Additionally, or alternatively, the UE may perform aspects of the described functions using special-purpose hardware.

At 1605, the method may include receiving a control message indicating to transmit an uplink message. The operations of 1605 may be performed in accordance with examples as disclosed herein. In some examples, aspects of the operations of 1605 may be performed by a control message manager 830 as described with reference to FIG. 8.

At 1610, the method may include precoding the uplink message to generate a precoded message for transmission via a set of multiple spatial layers in accordance with a distortion management configuration, where the distortion management configuration indicates a proportion of NL distortion to allocate to each spatial layer of the set of multiple spatial layers. The operations of 1610 may be performed in accordance with examples as disclosed herein. In some examples, aspects of the operations of 1610 may be performed by a precoded message manager 835 as described with reference to FIG. 8.

At 1615, the method may include transmitting the precoded message via the set of multiple spatial layers in accordance with the distortion management configuration. The operations of 1615 may be performed in accordance with examples as disclosed herein. In some examples, aspects of the operations of 1615 may be performed by a spatial layers manager 840 as described with reference to FIG. 8.

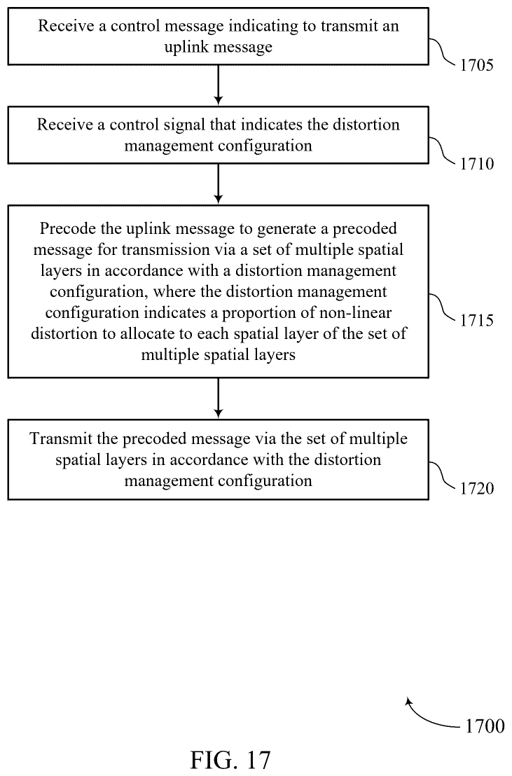

FIG. 17 shows a flowchart illustrating a method 1700 that supports techniques for allocating NL distortion to spatial layers in accordance with one or more aspects of the present disclosure. The operations of the method 1700 may be implemented by a UE or its components as described herein. For example, the operations of the method 1700 may be performed by a UE 115 as described with reference to FIGS. 1 through 9. In some examples, a UE may execute a set of instructions to control the functional elements of the UE to perform the described functions. Additionally, or alternatively, the UE may perform aspects of the described functions using special-purpose hardware.

At 1705, the method may include receiving a control message indicating to transmit an uplink message. The operations of 1705 may be performed in accordance with examples as disclosed herein. In some examples, aspects of the operations of 1705 may be performed by a control message manager 830 as described with reference to FIG. 8.

At 1710, the method may include receiving a control signal that indicates the distortion management configuration. The operations of 1710 may be performed in accordance with examples as disclosed herein. In some examples, aspects of the operations of 1710 may be performed by a distortion management configuration manager 825 as described with reference to FIG. 8.

At 1715, the method may include precoding the uplink message to generate a precoded message for transmission via a set of multiple spatial layers in accordance with a distortion management configuration, where the distortion management configuration indicates a proportion of NL distortion to allocate to each spatial layer of the set of multiple spatial layers. The operations of 1715 may be performed in accordance with examples as disclosed herein. In some examples, aspects of the operations of 1715 may be performed by a precoded message manager 835 as described with reference to FIG. 8.

At 1720, the method may include transmitting the precoded message via the set of multiple spatial layers in accordance with the distortion management configuration. The operations of 1720 may be performed in accordance with examples as disclosed herein. In some examples, aspects of the operations of 1720 may be performed by a spatial layers manager 840 as described with reference to FIG. 8.

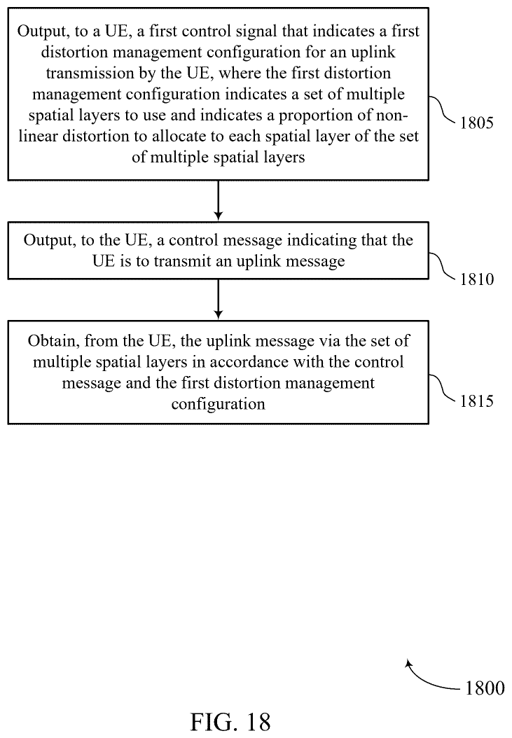

FIG. 18 shows a flowchart illustrating a method 1800 that supports techniques for allocating NL distortion to spatial layers in accordance with one or more aspects of the present disclosure. The operations of the method 1800 may be implemented by a network entity or its components as described herein. For example, the operations of the method 1800 may be performed by a network entity as described with reference to FIGS. 1 through 5 and 10 through 13. In some examples, a network entity may execute a set of instructions to control the functional elements of the network entity to perform the described functions. Additionally, or alternatively, the network entity may perform aspects of the described functions using special-purpose hardware.

At 1805, the method may include outputting, to a UE, a first control signal that indicates a first distortion management configuration for an uplink transmission by the UE, where the first distortion management configuration indicates a set of multiple spatial layers to use and indicates a proportion of NL distortion to allocate to each spatial layer of the set of multiple spatial layers. The operations of 1805 may be performed in accordance with examples as disclosed herein. In some examples, aspects of the operations of 1805 may be performed by a distortion management configuration manager 1225 as described with reference to FIG. 12.

At 1810, the method may include outputting, to the UE, a control message indicating that the UE is to transmit an uplink message. The operations of 1810 may be performed in accordance with examples as disclosed herein. In some examples, aspects of the operations of 1810 may be performed by a control message manager 1230 as described with reference to FIG. 12.

At 1815, the method may include obtaining, from the UE, the uplink message via the set of multiple spatial layers in accordance with the control message and the first distortion management configuration. The operations of 1815 may be performed in accordance with examples as disclosed herein. In some examples, aspects of the operations of 1815 may be performed by a spatial layers manager 1235 as described with reference to FIG. 12.

The following provides an overview of aspects of the present disclosure:
Aspect 1: A method for wireless communications by a UE, comprising: receiving a first control signal that indicates a distortion management configuration for an uplink transmission by the UE, wherein the distortion management configuration indicates a plurality of spatial layers to use and indicates a proportion of non-linear distortion to allocate to each spatial layer of the plurality of spatial layers; receiving a control message indicating to transmit an uplink message; precoding the uplink message to generate a precoded message for transmission via the plurality of spatial layers in accordance with the distortion management configuration; and transmitting the precoded message via the plurality of spatial layers in accordance with the control message.
Aspect 2: The method of aspect 1, wherein the distortion management configuration indicates one or more frequencies associated with each spatial layer of the plurality of spatial layers, the distortion management configuration indicating the proportion of non-linear distortion to allocate to the one or more frequencies.
Aspect 3: The method of aspect 2, wherein the one or more frequencies comprise one or more in-band frequencies or one or more out-of-band frequencies.
Aspect 4: The method of any of aspects 1 through 3, further comprising: determining a performance metric associated with the precoded message, wherein the performance metric is determined for the plurality of spatial layers.
Aspect 5: The method of aspect 4, wherein the performance metric is an error vector magnitude metric or an out-of-band metric associated with each spatial layer of the plurality of spatial layers.
Aspect 6: The method of aspect 1, further comprising: receiving an indication of a channel matrix associated with the uplink message, wherein the uplink message is precoded based at least in part on the channel matrix.
Aspect 7: The method of aspect 1, wherein the proportion of non-linear distortion to allocate to each spatial layer of the plurality of spatial layers is based at least in part on a quality of service of a data payload of the uplink message.
Aspect 8: The method of aspects 1, further comprising: receiving a second control signal that indicates a quality of service indicator associated with the uplink message, wherein the proportion of non-linear distortion to allocate to each spatial layer of the plurality of spatial layers is based at least in part on the quality of service indicator.
Aspect 9: The method of aspect 1, wherein the proportion of non-linear distortion to allocate to each spatial layer of the plurality of spatial layers is based at least in part on a channel characteristic.
Aspect 10: A method for wireless communications by a UE, comprising: receiving a control message indicating to transmit an uplink message; precoding the uplink message to generate a precoded message for transmission via a plurality of spatial layers in accordance with a distortion management configuration, wherein the distortion management configuration indicates a proportion of non-linear distortion to allocate to each spatial layer of the plurality of spatial layers; and transmitting the precoded message via the plurality of spatial layers in accordance with the distortion management configuration.
Aspect 11: The method of aspect 10, wherein the distortion management configuration indicates a distortion management matrix, and the distortion management matrix indicates a weighting factor to apply to a respective spatial layer of the plurality of spatial layers.
Aspect 12: The method of aspect 10, wherein the distortion management configuration indicates one or more frequencies associated with each spatial layer of the plurality of spatial layers, and the distortion management configuration indicates the proportion of non-linear distortion to allocate to the one or more frequencies.
Aspect 13: The method of aspect 12, further comprising: receiving a control signal that indicates the distortion management configuration.
Aspect 14: The method of aspect 13, wherein the distortion management configuration indicates one or more frequencies associated with each spatial layer of the plurality of spatial layers, and the distortion management configuration indicates the proportion of non-linear distortion to allocate to the one or more frequencies.
Aspect 15: The method of aspect 10, further comprising: determining a performance metric associated with the precoded message, wherein the performance metric is determined for the plurality of spatial layers.
Aspect 16: The method of aspect 15, wherein the performance metric is an error vector magnitude metric or an out-of-band metric associated with each spatial layer of the plurality of spatial layers.
Aspect 17: The method of aspect 10, further comprising: receiving an indication of a channel matrix associated with the uplink message, wherein the uplink message is precoded based at least in part on the channel matrix.
Aspect 18: The method of aspect 10, wherein the proportion of non-linear distortion to allocate to each spatial layer of the plurality of spatial layers is based at least in part on a quality of service of a data payload of the uplink message.
Aspect 19: The method of aspect 10, further comprising: receiving a control signal that indicates a quality of service indicator associated with the uplink message, wherein the proportion of non-linear distortion to allocate to each spatial layer of the plurality of spatial layers is based at least in part on the quality of service indicator.
Aspect 20: The method of aspect 10, wherein the proportion of non-linear distortion to allocate to each spatial layer of the plurality of spatial layers is based at least in part on a channel characteristic.
Aspect 21: A method for wireless communications by a first network equipment, comprising: outputting, to a UE, a first control signal that indicates a first distortion management configuration for an uplink transmission by the UE, wherein the first distortion management configuration indicates a plurality of spatial layers to use and indicates a proportion of non-linear distortion to allocate to each spatial layer of the plurality of spatial layers; outputting, to the UE, a control message indicating that the UE is to transmit an uplink message; and obtaining, from the UE, the uplink message via the plurality of spatial layers in accordance with the control message and the first distortion management configuration.
Aspect 22: The method of aspect 21, wherein the first distortion management configuration indicates one or more frequencies associated with each spatial layer of the plurality of spatial layers, the first distortion management configuration indicating the proportion of non-linear distortion to allocate to the one or more frequencies.
Aspect 23: The method of aspect 22, wherein the one or more frequencies comprise one or more in-band frequencies or one or more out-of-band frequencies.
Aspect 24: The method of any of aspects 21 through 23, further comprising: determining a performance metric associated with the uplink message, wherein the performance metric is determined for the plurality of spatial layers.
Aspect 25: The method of aspect 24, wherein the performance metric is an error vector magnitude metric or an out-of-band metric associated with each spatial layer of the plurality of spatial layers.
Aspect 26: The method of aspect 21, further comprising: obtaining, from a second network entity, a second control signal indicating a second distortion management configuration associated with one or more spatial layers of the plurality of spatial layers, wherein the second distortion management configuration indicates to allocate a non-linear distortion or to refrain from allocating the non-linear distortion to the one or more spatial layers of the plurality of spatial layers.
Aspect 27: The method of aspect 21, further comprising: outputting, to a second network entity, a second control signal indicating a second distortion management configuration associated with one or more spatial layers of the plurality of spatial layers, wherein the second distortion management configuration indicates to allocate a non-linear distortion or to refrain from allocating the non-linear distortion to the one or more spatial layers of the plurality of spatial layers.
Aspect 28: The method of aspect 21, further comprising: outputting an indication of a channel matrix associated with the uplink message.
Aspect 29: The method of aspect 21, wherein the proportion of non-linear distortion to allocate to each spatial layer of the plurality of spatial layers is based at least in part on a quality of service of a data payload of the uplink message.
Aspect 30: The method of aspect 21, further comprising: outputting, to the UE, a second control signal that indicates a quality of service indicator associated with the uplink message, wherein the proportion of non-linear distortion to allocate to each spatial layer of the plurality of spatial layers is based at least in part on the quality of service indicator.
Aspect 31: The method of aspect 21, wherein the proportion of non-linear distortion to allocate to each spatial layer of the plurality of spatial layers is based at least in part on a channel characteristic.
Aspect 32: A UE for wireless communications, comprising one or more memories storing processor-executable code, and one or more processors coupled with the one or more memories and individually or collectively operable to execute the code to cause the UE to perform a method of any of aspects 1 through 9.
Aspect 33: A UE for wireless communications, comprising at least one means for performing a method of any of aspects 1 through 9.
Aspect 34: A non-transitory computer-readable medium storing code for wireless communications, the code comprising instructions executable by one or more processors to perform a method of any of aspects 1 through 9.
Aspect 35: A UE for wireless communications, comprising one or more memories storing processor-executable code, and one or more processors coupled with the one or more memories and individually or collectively operable to execute the code to cause the UE to perform a method of any of aspects 10 through 20.
Aspect 36: A UE for wireless communications, comprising at least one means for performing a method of any of aspects 10 through 20.
Aspect 37: A non-transitory computer-readable medium storing code for wireless communications, the code comprising instructions executable by one or more processors to perform a method of any of aspects 10 through 20.
Aspect 38: A first network equipment for wireless communications, comprising one or more memories storing processor-executable code, and one or more processors coupled with the one or more memories and individually or collectively operable to execute the code to cause the first network equipment to perform a method of any of aspects 21 through 31.
Aspect 39: A first network equipment for wireless communications, comprising at least one means for performing a method of any of aspects 21 through 31.
Aspect 40: A non-transitory computer-readable medium storing code for wireless communications, the code comprising instructions executable by one or more processors to perform a method of any of aspects 21 through 31.

It should be noted that the methods described herein describe possible implementations. The operations and the steps may be rearranged or otherwise modified and other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, a graphics processing unit (GPU), a neural processing unit (NPU), an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration). Any functions or operations described herein as being capable of being performed by a processor may be performed by multiple processors that, individually or collectively, are capable of performing the described functions or operations.

The functions described herein may be implemented using hardware, software executed by a processor, firmware, or any combination thereof. If implemented using software executed by a processor, the functions may be stored as or transmitted using one or more instructions or code of a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk, and Blu-ray disc. Disks may reproduce data magnetically, and discs may reproduce data optically using lasers. Combinations of the above are also included within the scope of computer-readable media. Any functions or operations described herein as being capable of being performed by a memory may be performed by multiple memories that, individually or collectively, are capable of performing the described functions or operations.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

As used herein, including in the claims, the article “a” before a noun is open-ended and understood to refer to “at least one” of those nouns or “one or more” of those nouns. Thus, the terms “a,” “at least one,” “one or more,” and “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components.”

The term “determine” or “determining” encompasses a variety of actions and, therefore, “determining” can include calculating, computing, processing, deriving, investigating, looking up (such as via looking up in a table, a database, or another data structure), ascertaining, and the like. Also, “determining” can include receiving (e.g., receiving information), accessing (e.g., accessing data stored in memory), and the like. Also, “determining” can include resolving, obtaining, selecting, choosing, establishing, and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label or other subsequent reference label.

The description set forth herein, in connection with the appended drawings, describes example configurations and does not represent all the examples that may be implemented or that are within the scope of the claims. The term “example” used herein means “serving as an example, instance, or illustration” and not “preferred” or “advantageous over other examples.” The detailed description includes specific details for the purpose of providing an understanding of the described techniques. These techniques, however, may be practiced without these specific details. In some figures, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A user equipment (UE), comprising:
one or more memories storing processor-executable code; and
one or more processors coupled with the one or more memories and individually or collectively operable to execute the code to cause the UE to:
receive a first control signal that indicates a distortion management configuration for an uplink transmission by the UE, wherein the distortion management configuration indicates a plurality of spatial layers to use and indicates a proportion of non-linear distortion to allocate to each spatial layer of the plurality of spatial layers;
receive a control message indicating to transmit an uplink message;
precode the uplink message to generate a precoded message for transmission via the plurality of spatial layers in accordance with the distortion management configuration; and
transmit the precoded message via the plurality of spatial layers in accordance with the control message.

2. The UE of claim 1, wherein the distortion management configuration indicates one or more frequencies associated with each spatial layer of the plurality of spatial layers, the distortion management configuration indicating the proportion of non-linear distortion to allocate to the one or more frequencies.

3. The UE of claim 2, wherein:
the one or more frequencies comprise one or more in-band frequencies or one or more out-of-band frequencies.

4. The UE of claim 1, wherein the one or more processors are individually or collectively further operable to execute the code to cause the UE to:
determine a performance metric associated with the precoded message, wherein the performance metric is determined for the plurality of spatial layers.

5. The UE of claim 4, wherein the performance metric is an error vector magnitude metric or an out-of-band metric associated with each spatial layer of the plurality of spatial layers.

6. The UE of claim 1, wherein the one or more processors are individually or collectively further operable to execute the code to cause the UE to:
receive an indication of a channel matrix associated with the uplink message, wherein the uplink message is precoded based at least in part on the channel matrix.

7. The UE of claim 1, wherein the proportion of non-linear distortion to allocate to each spatial layer of the plurality of spatial layers is based at least in part on a quality of service of a data payload of the uplink message.

8. The UE of claim 1, wherein the one or more processors are individually or collectively further operable to execute the code to cause the UE to:
receive a second control signal that indicates a quality of service indicator associated with the uplink message, wherein the proportion of non-linear distortion to allocate to each spatial layer of the plurality of spatial layers is based at least in part on the quality of service indicator.

9. The UE of claim 1, wherein the proportion of non-linear distortion to allocate to each spatial layer of the plurality of spatial layers is based at least in part on a channel characteristic.

10. A user equipment (UE), comprising:
one or more memories storing processor-executable code; and
one or more processors coupled with the one or more memories and individually or collectively operable to execute the code to cause the UE to:
receive a control message indicating to transmit an uplink message;
precode the uplink message to generate a precoded message for transmission via a plurality of spatial layers in accordance with a distortion management configuration, wherein the distortion management configuration indicates a proportion of non-linear distortion to allocate to each spatial layer of the plurality of spatial layers; and
transmit the precoded message via the plurality of spatial layers in accordance with the distortion management configuration.

11. The UE of claim 10, wherein:
the distortion management configuration indicates a distortion management matrix, and
the distortion management matrix indicates a weighting factor to apply to a respective spatial layer of the plurality of spatial layers.

12. The UE of claim 10, wherein:
the distortion management configuration indicates one or more frequencies associated with each spatial layer of the plurality of spatial layers, and
the distortion management configuration indicates the proportion of non-linear distortion to allocate to the one or more frequencies.

13. The UE of claim 12, wherein the one or more processors are individually or collectively further operable to execute the code to cause the UE to:
receive a control signal that indicates the distortion management configuration.

14. The UE of claim 13, wherein:
the distortion management configuration indicates one or more frequencies associated with each spatial layer of the plurality of spatial layers, and
the distortion management configuration indicates the proportion of non-linear distortion to allocate to the one or more frequencies.

15. The UE of claim 10, wherein the one or more processors are individually or collectively further operable to execute the code to cause the UE to:
determine a performance metric associated with the precoded message, wherein the performance metric is determined for the plurality of spatial layers.

16. The UE of claim 15, wherein the performance metric is an error vector magnitude metric or an out-of-band metric associated with each spatial layer of the plurality of spatial layers.

17. The UE of claim 10, wherein the one or more processors are individually or collectively further operable to execute the code to cause the UE to:
receive an indication of a channel matrix associated with the uplink message, wherein the uplink message is precoded based at least in part on the channel matrix.

18. The UE of claim 10, wherein the proportion of non-linear distortion to allocate to each spatial layer of the plurality of spatial layers is based at least in part on a quality of service of a data payload of the uplink message.

19. The UE of claim 10, wherein the one or more processors are individually or collectively further operable to execute the code to cause the UE to:
receive a control signal that indicates a quality of service indicator associated with the uplink message, wherein the proportion of non-linear distortion to allocate to each spatial layer of the plurality of spatial layers is based at least in part on the quality of service indicator.

20. The UE of claim 10, wherein the proportion of non-linear distortion to allocate to each spatial layer of the plurality of spatial layers is based at least in part on a channel characteristic.

21. A first network equipment, comprising:
one or more memories storing processor-executable code; and
one or more processors coupled with the one or more memories and individually or collectively operable to execute the code to cause the first network equipment to:
output, to a user equipment (UE), a first control signal that indicates a first distortion management configuration for an uplink transmission by the UE, wherein the first distortion management configuration indicates a plurality of spatial layers to use and indicates a proportion of non-linear distortion to allocate to each spatial layer of the plurality of spatial layers;
output, to the UE, a control message indicating that the UE is to transmit an uplink message; and
obtain, from the UE, the uplink message via the plurality of spatial layers in accordance with the control message and the first distortion management configuration.

22. The first network equipment of claim 21, wherein:
the first distortion management configuration indicates one or more frequencies associated with each spatial layer of the plurality of spatial layers, and
the first distortion management configuration indicating the proportion of non-linear distortion to allocate to the one or more frequencies.

23. The first network equipment of claim 21, wherein the one or more processors are individually or collectively further operable to execute the code to cause the first network equipment to:
determine a performance metric associated with the uplink message, wherein the performance metric is determined for the plurality of spatial layers.

24. The first network equipment of claim 21, wherein the one or more processors are individually or collectively further operable to execute the code to cause the first network equipment to:
obtain, from a second network entity, a second control signal indicating a second distortion management configuration associated with one or more spatial layers of the plurality of spatial layers, wherein the second distortion management configuration indicates to allocate a non-linear distortion or to refrain from allocating the non-linear distortion to the one or more spatial layers of the plurality of spatial layers.

25. The first network equipment of claim 21, wherein the one or more processors are individually or collectively further operable to execute the code to cause the first network equipment to:
output, to a second network entity, a second control signal indicating a second distortion management configuration associated with one or more spatial layers of the plurality of spatial layers, wherein the second distortion management configuration indicates to allocate a non-linear distortion or to refrain from allocating the non-linear distortion to the one or more spatial layers of the plurality of spatial layers.

26. The first network equipment of claim 21, wherein the one or more processors are individually or collectively further operable to execute the code to cause the first network equipment to:
output an indication of a channel matrix associated with the uplink message.

27. The first network equipment of claim 21, wherein the proportion of non-linear distortion to allocate to each spatial layer of the plurality of spatial layers is based at least in part on a quality of service of a data payload of the uplink message.

28. The first network equipment of claim 21, wherein the one or more processors are individually or collectively further operable to execute the code to cause the first network equipment to:
output, to the UE, a second control signal that indicates a quality of service indicator associated with the uplink message, wherein the proportion of non-linear distortion to allocate to each spatial layer of the plurality of spatial layers is based at least in part on the quality of service indicator.

29. The first network equipment of claim 21, wherein the proportion of non-linear distortion to allocate to each spatial layer of the plurality of spatial layers is based at least in part on a channel characteristic.

30. A method for wireless communications by a user equipment (UE), comprising:
receiving a first control signal that indicates a distortion management configuration for an uplink transmission by the UE, wherein the distortion management configuration indicates a plurality of spatial layers to use and indicates a proportion of non-linear distortion to allocate to each spatial layer of the plurality of spatial layers;
receiving a control message indicating to transmit an uplink message;
precoding the uplink message to generate a precoded message for transmission via the plurality of spatial layers in accordance with the distortion management configuration; and
transmitting the precoded message via the plurality of spatial layers in accordance with the control message.
